(19) United States
(12) Patent Application Publication
(10) Pub. No.: US 2022/0186090 A1
(43) Pub. Date: Jun. 16, 2022

(54) REATTACHABLE ADHESIVE PRODUCTS

(71) Applicant: David Sieverding, Coeur d'Alene, ID (US)

(72) Inventor: David Sieverding, Coeur d'Alene, ID (US)

(21) Appl. No.: 17/546,148

(22) Filed: Dec. 9, 2021

Related U.S. Application Data
(60) Provisional application No. 63/124,262, filed on Dec. 11, 2020.
(60) Provisional application No. 63/134,902, filed on Jan. 7, 2021.

(51) Int. Cl. C09J 125/08

(52) U.S. Cl. CPC C09J 125/08

(57) ABSTRACT

A solid-phase adhesive that includes, based on 100 percent of the solids weight of the solid-phase adhesive, a low molecular weight resin, a triblock copolymer and a hydrophobic liquid. The low molecular weight resin is at a concentration of least 20 weight percent and is produced by the polymerization and hydrogenation of styrenic monomer feedstock having a ring and ball softening point of between about 10° C. and about 45° C. The triblock copolymer is at a concentration of between about 2 weight percent and about 40 weight percent and includes a saturated elastomeric block intermediate opposite ends thereof and a thermoplastic block on each end. The hydrophobic liquid is at a concentration of up to about 50 weight percent.

### REFERENCE TO RELATED APPLICATION

This application claims priority to Provisional Applic. No. 63/124,262, filed on Dec. 11, 2020; and Provisional Applic. No. 63/134,902, filed on Jan. 7, 2021, the contents of which are incorporated herein by reference.

### FIELD OF THE INVENTION

The invention relates generally to adhesives. More particularly, the invention relates to re-attachable solid-phase adhesive and devices.

### BACKGROUND OF THE INVENTION

U.S. Pat. No. 4,833,193 relates to thick gel-appearing films of ultra-low-modulus adhesives but incorrectly refers to them as “thick gel-appearing pressure-sensitive adhesives.” The inventor and his patent attorneys were not aware of the origin of the term “pressure-sensitive adhesive.” As a result, they mistakenly referred to the adhesive in these previous patent applications as pressure-sensitive adhesives because the only two terms used to describe adhesives of that time were pressure-sensitive and structural, neither of which applied to ultra-low-modulus solids with adhesive properties.

A previous invention, U.S. Pat. No. 4,833,193 discloses an ultra-low modulus solid-state adhesive made from three main ingredients REGALREZ 1018, KRATON G 1651, and mineral oil. It could also contain KRATON G 1701 or KRATON G 1702, which are styrene-ethylene/butylene (S-EB) diblock copolymers. In contrast, KRATON G 1651 is a styrene-ethylene/butylene-styrene (S-E/B-S) triblock copolymer.

According to its manufacturer, Eastman, “REGALREZ 1018 hydrocarbon resin is produced by polymerization and hydrogenation of pure monomer hydrocarbon feedstocks. REGALREZ 1018 is a highly stable, light-colored, low molecular weight, nonpolar liquid resin suggested for use in plastics modification, adhesives, coatings, sealants, and caulks. Due to its fully hydrogenated cycloaliphatic structure and low softening point, REGALREZ 1018 is useful as a plasticizer in systems where low color and thermal stability are primary concerns, and plasticizer migration must be minimized.”

According to its manufacturer, Kraton Corporation, “KRATON G1651 E is a transparent, linear triblock copolymer based on styrene and ethylene/butylene, S-E/B-S, with bound styrene of 31.5% mass. Kraton Corporation supplies KRATON G1651 from Europe in the two physical forms identified below.
KRATON G1651 EU—supplied as an undusted fluffy crumb
KRATON G1651 ES—supplied as a fluffy crumb dusted with amorphous silica.
KRATON G1651 E is used as a base material for compound formulations and as a modifier of thermoplastics. The inherent stability of the mid-block suggests using this product in applications that must withstand weathering and high processing temperatures.”

These adhesives were solids and had ultra-low modulus. Still, they were unaware that the term “pressure-sensitive adhesive” referred explicitly to viscoelastic adhesives. They could only find two adhesive classes in the literature, “pressure-sensitive adhesive” and “structural adhesive.” The term “structural adhesive” refers to liquid adhesives that undergo a change state to become solids. The name “pressure-sensitive adhesive” seemed to be the best fit. It referred to adhesives that do not go through a state change and because pressure-sensitive adhesives form an immediate bond, and structural adhesives do not.

U.S. Pat. No. 4,833,193 goes on to say, “films of at least 1 mil in thickness that release from a surface by adhesive failure, not a cohesive failure, and which one can use and reuse repeatedly. They are tacky to the touch and cleanly peel from the skin yet retain exceptional adhesive qualities to a wide variety of materials. Certain of the adhesives are distinguished for their ability to bond difficult to bond surfaces as polyethylene, polypropylene, and fluorinated hydrocarbon plastics. Others have a soft feel, which makes them eminently suitable for skin applications. The adhesives of the invention comprise a homogeneous mixture containing, based on 100% of the weight of the solids of the adhesive:
(i) At least 20 weight % of a low molecular weight resin produced by the polymerization and hydrogenation of styrenic monomer feedstock having a ring and ball softening point of about 10°−45° C.
(ii) From about 2 to about 40 weight % of a triblock copolymer with a saturated elastomeric block in the center and a thermoplastic block on each end alone or in combination with a diblock copolymer of a hard, thermoplastic block and a saturated, soft ethylene-butylene polymeric block
(iii) Up to about 80 weight % of mineral oil.

Pressure-sensitive adhesives are typically thin films less than about one mil. Since one can visualize them as liquids coated on a backing, they are not as functional as an adhesive when made into a thick film. Thick film pressure-sensitive adhesives have a thickness greater than about 1 mil, desirably greater than about 4 mils, more desirably greater than about 8 mils, preferably greater than about 12 mils, and most preferably, greater than about 20 mils. They have not found favor because they fail as a result of cohesive failure leaving a deposit of material on the surface from which they are removed.

Few pressure-sensitive adhesives function as thick films and have the following advantages:
(1) They are solids.
(2) They are repeatedly reusable.
(3) They possess soft tactility.
(4) They do not bond to the hair
(5) They span a wide variety of applications.

KRATON thermoplastic rubber polymers of the “G 1600 series” are a class of commercially available non-vulcanizable tri-block copolymers with a saturated elastomeric block in the center and a thermoplastic block on each end that is manufactured and sold by Kraton Corporation They are characterized as ideally suited to the formulation of solvent-based adhesives, sealants, and coatings.

This series of rubbers are characterized as possessing excellent resistance to degradation by oxygen, ozone, and U.V. light. The copolymers are two-phase block copolymeric structures, as evidenced by their two (2) Tg's. Attack of either phase by solvents, heat, resin additives, oils, and the like materials, have a profound effect on the performance characteristics and utility of these copolymeric rubbers Certain additives will attack the rubber phase of the copolymers, and others will attack their thermoplastic phases. Kraton Corporation teaches many commercial resins and plasticizers as useful in KRATON rubber formulations. In that context, Kraton Corporation has characterized “REGALREZ Series” as a “rubber phase associating resins” that one can use in KRATON rubber formulations That characterization is as follows.

| Rubber phase | Softening | | |
|---|---|---|---|
| associating resins | Point ° C. | Chemical Base | Manufacturer |
| REGALREZ Series | 17-125 | Hydrocarbon | Eastman Chemical |

A particularly preferred KRATON thermoplastic rubber from the standpoint of this invention is KRATON G-1651. It is a triblock polymer of an ethylene-1-butylene copolymer elastomer containing polystyrene end polymer groups. The following table compares KRATON G 1651 to KRATON G-1650, KRATON G-1652, KRATON GX-1657, and KRATON G-4609:

TABLE 1

| | KRATON | KRATON | KRATON | KRATON | KRATON |
|---|---|---|---|---|---|
| | G-1650 | G-1651 | G-1652 | G-1657 | G-4609 |
| Property | (SEBS)¹ | (SEBS) | (SEBS) | (SEBS) | (SEBS) |
| Tensile strength, psi² | 5,000 | >3,000 | 4,500 | 3,400 | 3,000 |
| 300% Modulus, psi³ | 800 | 700 | 700 | 350 | 200 |
| Elongation, %⁴ | 500 | 650 | 500 | 750 | 1,100 |
| Set at Break, % | — | — | — | — | 20 |
| Hardness Shore A | 75 | — | 75 | 65 | 37 |
| Specific Gravity | 0.91 | 0.92 | 0.91 | 0.90 | 0.90 |
| Viscosity⁵ | 1,500 | 2,000 | 550 | 1,100 | 4,000 |
| Plasticizer Oil Content, % w | 0 | 0 | 0 | 0 | 47 |
| Styrene/Rubber Ratio | 28/72 | 33/67 | 29/71 | 14/86 | 33/67 |
| Physical Form | Crumb | Crumb | Crumb | Crumb | Crumb |

¹Styrene-ethylene-butylene-styrene block copolymer
²ASTM method D412tensile tester jaw separation speed ten in./min. Typical properties determined on film cast from a toluene solution.
³See fn. 1 supra
⁴See fn. 1 supra
⁵Brookfield (toluene solution), cps at 77° F. (25° C.); neat polymer concentration, 20% w except for G4609, which is at a plasticized polymer concentration, 25% w.

Kraton Corporation indicated that KRATON G-1651 is the highest molecular weight rubber of those characterized in Table 1, supra, and the viscosity measurements in Table 1, supra, would tend to support that characterization.

Another series of the KRATON thermoplastic rubbers are the diblock polymers in which one block is a hard thermoplastic, and the other is a saturated soft elastomer. Illustrative of this series is KRATON G 1701, a diblock polymer of a hard-polystyrene block and a saturated, soft poly(ethylene-butylene) block. It is compatible with KRATON G 1652, and the blends of the two polymers are lower in strength than KRATON G 1652 alone. Typical properties of KRATON G-1701 are as follows:

TABLE 2
KRATON G-1701 Properties

| Tensile Properties⁶ | | |
|---|---|---|
| Tensile strength, psi (MPa) | 300 | (2.1) |
| Elongation at break, % | <100 | |
| Hardness, Shore A durometer | 81 | |
| Solution Viscosity⁷ | 1260 | (1.26) |
| 15% w. in toluene, cps (Pa-s) | | |
| Styrene/rubber ratio | 37/63 | |
| Physical Form | Crumb | |

⁶Measured on films cast from toluene, Instron jaw separation rate 1 inches per minute (250 mm per minute), temperature 25° C., dumbbell specimens cut with ASTM die D.
⁷Measured at 25° C. using a Brookfield Model RVT viscometer with a number 21 spindle.

REGALREZ resins are manufactured and sold by Eastman Chemical, which characterizes them as hydrogenated pure monomer resins. They are understood to be styrenic monomers derived from styrene, alpha-methyl styrene, vinyl toluene, and the like. From the standpoint of this invention, desirable REGALREZ resins are those which (1) are liquid at room temperature (about 23° C.), (2) have a low softening point, determined by the ring and ball method, and (3) have a second-order transition temperature (Tg) below about 30° C., preferably below about 0° C. The following table cites the typical properties of relevant REGALREZ resins:

TABLE 3

| REGALREZ Resin | 1018 | 1033 | 1065 | 1078 |
|---|---|---|---|---|
| Ring & Ball softening point, ° C. | 18 | 32 | 65 | 76 |
| Glass Transition Temp., ° C. | −22 | −9 | 16 | 26 |
| Specific Gravity | .942 | .943 | .948 | .948 |
| Melt Viscosity, ° C. | | | | |
| @ 100 cps. | 90 | 105 | 160 | 165 |
| @ 1,000 cps. | 55 | 75 | 120 | 135 |
| @ 10,000 cps. | 35 | 55 | 100 | 120 |
| Cloud Point ° C., in | | | | |
| Diacetone alcohol/xylene 1:1 | 14 | 32 | 33 | 38 |
| Methylcyclohexane/aniline 1:2 | 63 | 71 | 80 | 84 |
| Odorless mineral spirits | <−40 | <−40 | <−40 | <−40 |
| Molecular weight | | | | |
| M_{w} | 407 | 493 | 723 | 819 |
| Mₙ | 374 | 390 | 601 | 654 |
| M_{W}/M_{N} | 1.09 | 1.27 | 1.20 | 1.25 |

As pointed out above, REGALREZ resins have been suggested for use in combination with KRATON thermoplastic rubbers. The mix has been recommended for the manufacture of pressure-sensitive adhesives. In each instance, the amount of the KRATON rubber employed in the adhesive is a substantial portion of the adhesive formulation. In some instances, the amount of KRATON rubber recommended is greater than or equal to tie amount of any REGALREZ resins employed. Illustrative of prior art adhesive formulations are the following:

TABLE 4

| Formulation No. | A | B | C | D | E | F | G | H |
|---|---|---|---|---|---|---|---|---|
| KRATON F-1657 | 49.8 | 40.6 | 36.0 | 31.1 | 31.6 | 30.0 | 33.0 | 35.0 |
| REGALREZ 1078 | 18.9 | 7.8 | — | 36.8 | — | 30.0 | — | 20.0 |
| REGALREZ 1065 | — | 30.3 | 32.0 | — | 35.8 | — | 33.0 | — |
| REGALREZ 1033 | 31.3 | 21.3 | 32.0 | 32.1 | 32.6 | 40.0 | 34.0 | — |
| REGALREZ 1018 | — | — | — | — | — | — | — | 45.0 |
| Total | 100 | 100 | 100 | 100 | 100 | 100 | 100 | 100 |
| Phys Properties | | | | | | | | |
| Viscosity @ 350° F⁸ | 110 | 50 | 30 | 23 | 18 | 14 | | |
| Softening pt ring & ball ° C.⁹ | 42 | 49 | 44 | 48 | 44 | 44 | 43.5 | |
| Calc T_{g-}° C. | −31 | −23 | −23 | −17 | −18 | −18 | −18 | −27 |
| RDS T_{g-}° C. | −20 | −10 | −7 | 0 | 0 | 2 | | |
| Plateau Modulus, psi | 51 | 36 | 29 | 23 | 17 | 16 | | |
| Adhesive Properties | | | | | | | | |
| Rolling ball tack, cm. | 2.2 | 2.2 | 2.9 | 5.6 | 4.2 | 5.6 | | 2.2 |
| Polyken tack gm/cm² | 505 | 490 | 635 | 860 | 820 | 1205 | | 600 |
| 90° quick stick oz./in. | 9 | 5 | 18 | 13 | 46 | 59 | | |
| 180° peel adhesion oz./in | 20 | 8 | 36 | 27 | 75 | 88 | | 24 |

⁸@ 350° F. (177° C.), 1,000 cps.
⁹Ring & ball, ° C.

The above formulations and data suggest that the most effective adhesive is formulation F containing 30 weight % KRATON G-1657. It employs a combination of REGALREZ 1078, the highest softening temperature and molecular weight of the resins characterized in Table 3 above, and 1033, the second-lowest softening temperature and molecular weight of the resins characterized in Table 3 above. That formulation had better than two times the adhesive properties in respect to each of the properties commonly measured than formulations A. B. and H, and close to that in respect to formulation C. Overall, it has vastly superior properties to the other formulations, namely D and E. Interestingly, it had the same rolling ball tack as formulation D, yet it is significantly superior as to the remaining properties measured Thus, a common adhesive property fails to connote common overall adhesive properties. The deviations of the average of the molecular weights of the resins in these formulations to the base average molecular weight (100%) taken from the average molecular weight of the resin mixture of formulation number F are as follows.

| Formulation Number | A | B | C | D | E | F | G | H |
|---|---|---|---|---|---|---|---|---|
| % of the base molecular | 97 | 103 | 96 | 105 | 97 | 100 | 96 | 84 |
| weight value | | | | | | | | |

Hercules (the original manufacturer of REGALREZ resins) originally introduced REGALREZ 1065, 1078, 1033, and 1018 as RES-D-150, 151, 45, and 44. Eastman Chemical now manufactures these. A “Development Data” sheet published by Hercules Incorporated set forth the pressure-sensitive adhesive formulations and performance properties. They are repeated in Table 5 below.

TABLE 5

| TYPICAL COMPOUNDS | A | B | C | D |
|---|---|---|---|---|
| KRATON GX-1657 | 35 | 40 | 30 | 30 |
| RES-D-150 (now | — | — | 35 | — |
| REGALREZ 1065) | | | | |
| RES-D-151 (now | 45 | 42 | — | 40 |
| REGALREZ 1078) | | | | |
| RES-D-44 (now | 20 | 18 | — | 30 |
| REGALREZ 1033) | | | | |
| RES-D-45 (now | — | — | 35 | — |
| REGALREZ 1018) | | | | |
| T_{g} of Compound, ° C. | −17 | −20 | −15 | −17 |

PERFORMANCE PROPERTIES

| | | | | |
|---|---|---|---|---|
| Polyken Tack, gms/cm² | 1020 | 820 | 1000 | 930 |
| Quick Stick, oz/lin. in. | 30 | 22 | 32 | 27 |
| Rolling Ball Tack, cm | 7 | 7 | 9 | 8 |
| 180° Peel, oz/lin. in. | 50 | 43 | 51 | 45 |
| 178° Hold to Steel, | >5,000 | >5,000 | >5,000 | >5,000 |
| Min. @ 20° C., 1000 gm wt. | 80 | 92 | 80 | 75 |
| SAFT, ° C., 1000 gm wt., | | | | |
| 1″ × 1″ | | | | |

Bulletin OR-218A of Hercules Incorporated, Wilmington, Del., comprises a reprint of an article by Curtis DeWalt, published in Adhesive Age, March 1970, entitled: “Factors in Tackification.” At page 2 of the bulletin, the first page of the article, DeWalt states:
If we think of a tackifying resin as a solvent for the rubber—a solid-state solvent—we have the first step to a description of how a resin may tackify a rubber, that is, by bringing out the smaller, tack-bestowing molecules from their burial in the mass of the rubber.
Dr. Frank Wetzel of Hercules has provided an additional fact. He has shown a submicroscopic heterogeneity that appears to coincide with maximum tackiness. This, Dr. Wetzel described as showing the existence of two phases: At maximum tack—maximum heterogeneity as the rubber-to resin ratio is changed. His electron micrographs (FIG. 1) show natural rubber a homogeneous mass (upper left); small particles of a second phase at 25 percent resin (upper right); and the heterogeneity building to near equal amounts of two phases at 50 and 60 percent resin (left and right center) with particle diameters of about 1 micron. Then at 83 and 90 percent resin (lower left and right) there is an approach to homogeneity again.

The caption to FIG. 1 of the article reads as follows:

Electonmicrographs of replicas of pressure-sensitive adhesive films of ‘Pentalyn’ H (Pentaerythritol ester of hydrogenated rosin)-natural rubber. (Mag. 11,000X)(133,149)

(a) Natural rubber, tack value-200 to 300

(b) 1:3 Pentalyn H-rubber, tack value-320

(c) 1:1 Pentalyn H-rubber, tack value-590

(d) 3:2 Pentalyn H-rubber, tack value-1,100 to 1,200

(e) 5:1 Pentalyn H-rubber, tack value-0

(e) 9:1 Pentalyn H-rubber, tack value-0

DeWalt, at page 5 of the bulletin (page 4 of the article), makes the following comments regarding the molecular weight of the resin additive:

Concerning the molecular weights of resins, usually the smaller the molecule, the higher the solvency power—as with monomeric solvents.

While low molecular weight in a resin is desirable, there is a practical limit to this. A resin becomes a liquid as its molecular size is reduced, and almost any resin will act as a tackifier if its softening point is low enough. But adhesives made with soft resins lack in cohesive strength.

It would appear from this art that desirable adhesives employ low molecular weight resins in limited amounts, certainly below about 80 weight percent of the weight of the adhesive formulation.

Chmiel et al., U.S. Pat. No. 4,501,842, describe an adhesive for bonding cured EPDM membranes comprising, among other things, a halogenated butyl rubber, a pre-crosslinked butyl rubber, KRATON G-1652, Piccovar™ AB180, 10 and an aliphatic isocyanate.

Albers, U.S. Pat. No. 4,609,697, describes a hot melt adhesive comprising a KRATON G rubber having a styrene to olefin ratio of about 30:70 (the specific one is not mentioned), an aliphatic hydrocarbon resin, an aromatic hydrocarbon resin, and, as an optional ingredient, a bitumen material.

Duvdevani, U.S. Pat. No. 4,313,867, describes an injection moldable elastomeric composition which contains a KRATON G series rubber, a specific neutralized sulfonated EPDM terpolymer, an isotactic polypropylene homopolymer, and a non-polar backbone process oil.

### SUMMARY OF THE INVENTION

This invention relates to a family of solid-phase adhesives that consist of hydrophobic, ultra-low modulus, elastomeric solids that stretch to wet and adhere to human skin and other surfaces on contact. These solid-phase adhesives are distinct from pressure-sensitive adhesives, which have viscoelastic properties, combining liquid-state and solid-state properties. In contrast, the solid-phase adhesives of this invention are ultra-low-modulus solids. The solid-phase adhesives have advantages over pressure-sensitive adhesives, especially when the adherend is human skin and hair.

This invention also relates to new and useful compositions of matter made by either dispersing powdered hydrocolloids into the solid-phase adhesives or dispersing powdered hydrocolloids into the adhesive disclosed in U.S. Pat. No. 4,833,193. These dispersed hydrocolloids will enable the resulting adhesives to absorb moisture, such as sweat and wound exudate. Absorbing water will reduce or prevent skin maceration and prolong the time that products based on the solid-phase adhesive will adhere to the skin. One can use a mixer kettle, Banbury mixer, Banbury continuous mixer, sigma blade mixer, twin-screw extruder, or any other type of heated mixer for dispersing the hydrocolloids in either kind of molten adhesive. The mixer kettle appears to be the most cost-effective mixer type.

Any of several hydrocolloids are acceptable. Sodium carboxymethyl cellulose powder is generally preferred. Other usable hydrocolloids include but are not limited to hydroxyethylcellulose powder, microcrystalline cellulose, xanthan gum, fructan gum, carrageenan, acacia senegal gum, tara gum, caesalpinia spinosa gum, guar gum, rhizobian gum, sclerotium gum, dehydroxanthan gum, natto gum, carboxymethylcellulose, biosaccharide gum-4, biosaccharide gum-2, hydrolyzed soy protein, biosaccharide gum-1, ceratonia siliqua (carob) gum, chondrus crispus, bentonite, agar, inulin, maltodextrin, polyglutamic acid, most particularly sodium carboxymethyl cellulose powder. Sodium carboxymethyl cellulose powder and other water-swellable gums do not dissolve in the solid-phase adhesive but instead disperses in them.

This invention also relates to wearable devices, including wearable medical devices, personal care devices, electronic devices, athletic devices, high-tech devices, sporting devices, recreational devices, transportation devices, diving devices, safety devices, and telemetric devices that adhere to human skin by way of the ultra-low modulus, solid-phase adhesives, whether the solid-phase adhesives with or without added hydrocolloids, such as sodium carboxymethycellulose.

This invention also relates to devices that simply require ultra-low modulus, but not necessarily adhesivity. Examples include bedding or pads to reduce decubitus ulcer formation, seating, shoe insoles, and energy-absorbing material for reducing injury, especially brain injury, from sports and explosive devices encountered in warfare.

The term “pressure-sensitive adhesives” applies to viscoelastic materials (materials that display both viscous and elastic traits) that strike a balance between flow (viscosity) and resistance-to-flow (elasticity). The bond forms between the pressure-sensitive adhesive and the adherend because the pressure-sensitive adhesive has enough viscous flow to wet the adherend. The bond has strength because the pressure-sensitive adhesive has enough resistance to flow (elasticity) to maintain adhesion when the bond is stressed.

Unlike pressure-sensitive adhesives, which, being viscoelastic, require the application of pressure to cause them to flow to form a bond, the solid-phase adhesives adhere upon contact.

Unlike pressure-sensitive adhesives, which flow viscously to wet the adherend, the solid-phase adhesives stretch elastically to wet the adherend. The Young's modulus of these solid-phase adhesives is low enough so that the mechanical stress (force per unit area) required to stretch them to conform to the skin's surface, or other surfaces, is lower than the mechanical stress (force per unit area) created by the intermolecular forces and Van der Waals forces that cause wetting behavior.

Unlike pressure-sensitive adhesives, which tend to flow viscously into the skin and flow viscously to surround individual hairs, the solid-phase adhesives, being elastomeric solids, can stretch but cannot flow. Consequently, the solid-phase adhesives cover human skin and individual hairs like a blanket (which is also solid) covering a sleeping person, allowing one to remove these adhesives as though they are a blanket, without damaging both skin and hair.

Intermolecular forces, including van der Waals forces, are the only forces holding these solid-state elastomeric adhesives onto the skin. These forces are not strong enough to cause skin and hair trauma upon removal, but they are highly reliable.

When applied to human skin and then removed, pressure-sensitive adhesives typically become coated with removed skin and hair, losing most of their adhesivity. However, the solid-phase adhesives can be applied to the skin and removed many times without losing their adhesivity.

Unlike pressure-sensitive adhesives, which frequently cause medical adhesive-related skin injuries (“MARSI”) upon removal, these solid-phase adhesives can be applied to and removed from human skin repeatedly without causing MARSI.

MARSI occurs when a pressure-sensitive adhesive removes superficial layers of skin, causing erythema or other skin trauma manifestation or reaction, including the formation of vesicles, bullae, skin erosion, and skin tears that persist longer than 30 minutes after removal of the adhesive. MARSI affects skin integrity and causes pain, increases the risk of infection, potentially increases wound size, and delays healing. MARSI can be so severe as to require skin grafts, especially in premature babies and the elderly. MARSI occurs whenever pressure-sensitive adhesive is applied and removed from human skin regardless of whether the context is medical or otherwise.

Often, medical personnel will remove and replace bandages or other devices many times during treatment. Each time one removes pressure-sensitive adhesive from the skin, it tends to cause progressively worsening MARSI and worsening pain for the patient. MARSI can worsen to the point where it requires medical treatment, which may include skin grafts.

The solid-phase adhesives are also unlike pressure-sensitive adhesives in that they work best in the form of thick films, preferably about twenty mils or thicker. In contrast, pressure-sensitive adhesives work best as thin films, preferably two mils or thinner. The solid-phase adhesives are also unlike pressure-sensitive adhesives because they tend to fully recover their shape when applied to and removed from the skin or other surfaces while pressure-sensitive adhesives do not.

Pressure-sensitive adhesives, being viscoelastic and capable of flow, tend to flow into the skin and flow around the hair, enveloping it. As a result of this flow, pressure-sensitive adhesives tend to lock onto the skin and hair so firmly that one cannot remove them without causing skin trauma and, if the hair is present, causing hair trauma as well. However, it is possible to make pressure-sensitive adhesives that adhere so poorly that they cause little or no skin trauma upon removal. Unfortunately, these poorly adhering pressure-sensitive adhesives tend not to be reliable enough for medical applications.

Because the solid-phase adhesives stretch instead of flow, they tend to separate cleanly at the interface between themselves and the skin or hair without causing skin or hair trauma. However, they tend to be reliable enough for many, if not most, skin-contact applications, including medical applications. Since they separate cleanly, they can be pulled off and reattached many times, thus opening many new applications that require the ability to reattach. The invention includes many such applications.

The solid-phase adhesives are also unlike pressure-sensitive adhesives because they stretch laterally to accommodate lateral movement with less pulling of the skin. They also compress tangentially to distribute tangential pressure better.

These properties make them better suited than pressure-sensitive adhesives for adhering medical devices, personal care devices, electronic devices, and other devices to the human body. One can also apply the adhesive materials to surfaces other than skin. They can be repeatedly attached and removed from many hard surfaces without damaging these surfaces.

The solid-phase adhesive comprises a low softening point, high viscosity cycloaliphatic hydrocarbon resin produced by polymerization and hydrogenation of hydrocarbon feedstocks. One such resin is REGALREZ 1018. The solid-phase adhesive also comprises a lower viscosity hydrophobic liquid, such as ExxonMobil's Puresyn 2 Hydrogenated Poly(C6-14 Olefin). The invention also includes a high molecular weight styrene-ethylene/butylene-styrene block copolymer, such as Kraton Corporation's KRATON G-1651. The invention may also comprise a hydrocolloid such as sodium carboxy-methyl cellulose.

According to Eastman, REGALREZ 1018 is a hydrocarbon resin produced by polymerization and hydrogenation of pure monomer hydrocarbon feedstocks. REGALREZ 1018 is a highly stable, light-colored, low molecular weight, non-polar liquid resin suggested for use in plastics modification, adhesives, coatings, sealants, and caulks. REGALREZ 1018 has a fully hydrogenated cycloaliphatic structure and low softening point.

This invention comprises MARSI-free, re-attachable ultra-low-modulus adhesives released from human skin by adhesive failure, not the human skin's failure, and wearable devices secured by the MARSI-free, re-attachable ultra-low-modulus adhesives. These MARSI-free, re-attachable, ultra-low-modulus adhesives are highly suitable for wearable devices and do not have the disadvantages of pressure-sensitive adhesive. This re-attachable adhesive stretches elastically to wet the skin and adhere. Because it only stretches elastically and does not flow viscously, however, this MARSI-free, re-attachable adhesive cannot flow around hair or be absorbed into the skin. It just lays on top of each like a blanket, thus allowing this ultra-low-modulus elastic adhesive to be removed with minimal damaging the skin, pulling the hair out, or losing its adhesivity.

One can pull MARSI-free, re-attachable ultra-low-modulus adhesive devices off the skin without injury, much as one can draw a magnet off a steel surface to which it is attached. This behavior makes applying and removing MARSI-free, re-attachable ultra-low-modulus adhesive devices from skin appear like applying and removing weak magnets from steel.

Like a magnet and steel, the skin can adhere to and separate from MARSI-free, re-attachable ultra-low-modulus adhesives repeatedly. The attraction occurs automatically when the distance between the human skin or another solid-state substrate and the ultra-low-modulus adhesive is sufficiently short that intermolecular forces, such as van Der Waals forces, can overcome the ultra-low-modulus adhesive's resistance to conform to the opposing surface. Separation occurs when the opposing mechanical force exceeds this attraction. Fortunately, the stress (force per unit area) required to pull off a device held on by an ultra-low-modulus adhesive is too low to cause skin or hair trauma.

Unlike pressure-sensitive adhesives, ultra-low-modulus elastic solid-state adhesive adheres on contact without the need for applied pressure. MARSI-free, re-attachable, ultra-low-modulus-adhesive devices can, typically, be applied and removed and reapplied many times without damaging the skin, hair, or the MARSI-free, re-attachable, ultra-low-modulus-adhesive devices.

The re-attachable adhesive devices include, but are not limited to, bidirectional pathogen barrier surgical mask that filters both inhaled and exhaled air which may or may not incorporate an optional oxygen fitting and optional oximeter, a bidirectional pathogen barrier n-95 mask which may or may not incorporate an optional oxygen fitting and optional oximeter, panty-line-free panties, panty-line-free panties with built-in panty liner, panty-line-free panties with built-in sanitary napkin, medical adhesive tape, fashion adhesive tape, fashion and toupee adhesive double sided, adhesive nipple covers, adhesive strapless-backless brassiere, adjustable adhesive strapless-backless brassiere, medical device and/or electronic device adhesive, transdermal drug delivery system, analgesic patch, acne patch, bug bite patch, athletic tape, removable perfume patch, adhesive bandage, adhesive sharps disposal pad, ostomy skin barrier and hydrocolloid dressing, adhesive goggles, strapless shin guard, rug adhesive, external breast prosthesis adhesive, strapless elbow pad, cranial guard, breathing strip, adhesive sandal, American football shoulder pad with adhesive shock absorber on inner surface, moisturizing face mask, one magnet multipurpose mounting device, two magnet multipurpose mounting device, three magnet multipurpose mounting device, two magnet multipurpose mounting device holding face shield, two magnet multipurpose mounting device, shaped adhesive brassiere, lift brassiere, adhesive nose guard, decubitus ulcer mitigation pad, sports helmet with shock padding, gem dots, cosmetic foil, RFID sticky, stick-on camera, eye bag sleep moisturizer, loop multipurpose mounting device, two loop multipurpose mounting device, three loop multipurpose mounting device, snap multipurpose mounting device, two snap multipurpose mounting device, three snap multipurpose mounting, face shield and two magnet multipurpose mounting device holding face shield, hook and loop mounting tape, heel guard, decubitus ulcer mitigation pad, amputee stump sleeve, corn remover strip, callus cushion, adhesive gel toe separator, ball blister cushion, heel blister cushion, toe blister cushion, bunion cushion, bunion cushion, exfoliating foot peel, breast pump interface, flexible magnetic tape, and flexible magnetic sheet.

This invention also relates to thick gel-appearing, re-attachable solid-phase adhesives films of at least one mil, but preferably about 20 mils in thickness that release from the skin by adhesive failure, not the human skin's failure. As a result, one can use them on the skin repeatedly. They are tacky to the touch and cleanly peel from the skin yet retain exceptional adhesive qualities to a wide variety of materials. Many have a soft feel, which makes them eminently suitable for skin applications. The solid-phase adhesives comprise a homogeneous mixture containing, based on 100% of the weight of the solids of the solid-phase adhesive:
(i) at least 20 weight % of a low molecular weight resin produced by the polymerization and hydrogenation of styrenic monomer feedstock having a ring and ball softening point of about 10°−45° C. In certain embodiments, the concentration of the low molecular weight resin in the solid-phase adhesive is between about 70 weight % and about 95 weight %.
(ii) from about 2 to about 40 weight % of a triblock copolymer with a saturated elastomeric block in the center and a thermoplastic block on each end alone or in combination with a diblock copolymer of a hard, thermoplastic block and a saturated, soft ethylene/butylene polymeric block.
(iii) up to about 50 weight % of a hydrophobic liquid which may include but is not limited to butyl stearate, butyloctanol, C12 alcane, C12-17 alcane, C14-22 alcane, caprylic/capric triglyceride, coco-caprylate, cocoyl adipic acid/trimethylolpropane copolymer, dicaprylyl ether, diethylhexyl sebacate, diisobutyl adipate, 1,2-cyclohexane dicarboxylic acid diisononyl ester, diisostearyl fumarate, diisostearyl malate, dimerdiol-carbonate, isododecane, hexyldecanol, hydrogenated poly(C6-14 olefin), hydrogenated polydecine, isononyl isononanoate, isopropyl shea butterate (and) dodecane (and) hexadecane, isostearyl isostearate, isostearyl lactate, lauryl lactate, lauryl lactyl lactate, neopentyl glycol diethylhexanoate, octyldodecanol, octyldodecyl lactate, octyldodecyl stearateo octyldodecyl stearoyl stearate, oleyl alcohol, oleyl erucate, oleyl lactate, PEG/PPG-8/3 diisostearate, polybutene, PPG-26/dimer dilinoleate copolymer (and) isononyl isononanoate (and) ethylhexyl isononanoate, propylene glycol dicaprylate/dicaprate, propylheptyl caprylate, triisostearyl citrate, undecane (and) tridecane) and combinations thereof. In certain embodiments, the concentration of the hydrophobic liquid in the solid-phase adhesive is between about 1 weight % and about 15 weight %.

The solid-phase devices can comprise the solid-phase MARSI-free, re-attachable, ultra-low-modulus solid-phase adhesives. Both types of re-attachable, ultra-low-modulus adhesive comprise relatively thick films consisting of a homogeneous mixture based on 100% of the solids' weight of the relatively thick films. This invention also relates to the solid-phase adhesives mixed with hydrocolloid powders up to 80% of total weight.

A preferred hydrocolloid is sodium carboxymethyl cellulose. These powdered hydrocolloids may include but are not limited to sodium carboxymethyl cellulose, hydroxyethylcellulose, microcrystalline cellulose, xanthan gum, fructan gum, carrageenan, acacia senegal gum, tara gum, caesalpinia spinosa gum, guar gum, rhizobium gum, sclerotium gum, dehydroxanthan gum, natto gum, carboxymethylcellulose, biosaccharide gum-4, biosaccharide gum-2, hydrolyzed soy protein, biosaccharide gum-1, ceratonia siliqua (carob) gum, chondrus crispus, bentonite, agar, inulin, maltodextrin, polyglutamic acid, neutralized polyacrylic acid, neutralized methacrylic acid, polyquaternium-7 (neutralized 2-propen-1-aminium, N, N-dimethyl-N-2-propenyl-, chloride, polymer with 2-propenamide), neutralized dimethylaminoethyl methacrylate, neutralized 3-trimethylammonium propyl methacrylamide, neutralized 3-dimethylaminopropyl methacrylamide, neutralized acrylates copolymer, hydroxypropyl methylcellulose, hydroxypropyl cellulose, neutralized 2-propen-1-aminium, N,N-dimethyl-N-2-propenyl-, polymer with 2-propenoic acid, neutralized poly(diallyldimethylammonium, neutralized 2-propen-1-aminium, N,N-dimethyl-N-2-propenyl-, chloride, polymer with 2-propenamide and 2-propenoic acid, butendiol/vinyl alcohol copolymer, polyvinylpyrrolidone, polyvinyl caprolactam, carbomer, polyethylene glycol, polyethylene oxide, polyquaternium-10, guar hydroxypropyltrimonium chloride, cetyl hydroxyethylcellulose, sodium polystyrene sulfonate, schizophyllan, polyethyloxazoline, PEG-8 dimethicone (and) PEG-8 ricinoleate, calcium/sodium PVM/MA copolymer, 2-propenoic acid, 2-methyl-, polymer with butyl 2-propenoate and methyl 2-methyl-2-propenoate, galactoarabinan, carbomer 980 QD, and polyvinyl amide.

This invention also relates to the devices mentioned earlier where the MARSI-free, re-attachable, ultra-low modulus, re-attachable solid-phase adhesives contain up to 80% of the hydrocolloid.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates stretching of a solid phase adhesive prepared according to an embodiment of the invention.

FIG. 2 is an adhesive bidirectional pathogen barrier surgical mask.

FIG. 3 shows a male wearing an adhesive bidirectional pathogen barrier surgical mask.

FIG. 4 shows a make wearing an adhesive bidirectional pathogen barrier N95 mask.

FIG. 5 shows a female wearing an adhesive bidirectional pathogen barrier KN95 mask,

FIG. 6 is panty-line free adhesive panties,

FIG. 7 is adhesive panties with built-in mini pad,

FIG. 8 is adhesive panties with built-in maxi pad,

FIG. 9 is an adhesive medical tape,

FIG. 10 is an adhesive fashion tape,

FIG. 11 is an adhesive double-sided fashion and toupee tape.

FIG. 12 is adhesive nipple covers.

FIG. 13 is an adhesive strapless, backless brassiere.

FIG. 14 is an adjustable adhesive strapless, backless brassiere.

FIG. 15 is an adhesive medical device and/or electronic device.

FIG. 16 is an adhesive transdermal drug delivery system.

FIG. 17 is an adhesive analgesic patch.

FIG. 18 is an adhesive acne patch.

FIG. 19 is an adhesive bug bite patch.

FIG. 20 is athletic tape.

FIG. 21 is a removable perfume patch.

FIG. 22 is an adhesive bandage.

FIG. 23 is an adhesive sharps disposal pad.

FIG. 24 is an ostomy skin barrier and hydrocolloid dressing.

FIG. 25 is adhesive goggles.

FIG. 26 is an adhesive strapless shin guard.

FIG. 27 is a rug adhesive.

FIG. 28 is an adhesive external breast prosthesis.

FIG. 29 is an adhesive strapless elbow pad.

FIG. 30 is an adhesive cranial guard.

FIG. 31 is an adhesive breathing strip.

FIG. 32 is an adhesive sandal.

FIG. 33 is an American football shoulder pad with adhesive shock absorber on inner surface.

FIG. 34 is a moisturizing face mask.

FIG. 35 is an adhesive one magnet multipurpose mounting device.

FIG. 36 is an adhesive two magnet multipurpose mounting device.

FIG. 37 is an adhesive three magnet multipurpose mounting device.

FIG. 38 is another embodiment of the adhesive three magnet multipurpose mounting device.

FIG. 39 is an adhesive two magnet multipurpose mounting device holding a face shield.

FIG. 40 is an adhesive shaped brassiere.

FIG. 41 is an adhesive lift brassiere.

FIG. 42 is an adhesive nose guard.

FIG. 43 is an adhesive decubitus ulcer mitigation pad.

FIG. 44 is a sports helmet with shock padding

FIG. 45 are adhesive gem dots.

FIG. 46 is an adhesive cosmetic foil.

FIG. 47 is an RFID sticky.

FIG. 48 is a stick-on camera.

FIG. 49 is eye bag reducing emollient.

FIG. 50 is an adhesive loop multipurpose mounting device.

FIG. 51 is an adhesive two loop multipurpose mounting device.

FIG. 52 is an adhesive three loop multipurpose mounting device.

FIG. 53 is an adhesive snap multipurpose mounting device.

FIG. 54 is an adhesive two snap multipurpose mounting device.

FIG. 55 is an adhesive three snap multipurpose mounting device.

FIG. 56 is another embodiment of the adhesive three snap multipurpose mounting device.

FIG. 57 is a face shield and adhesive two snap multipurpose mounting device holding the face shield.

FIG. 58 is a loop portion of a hook and look mounting tape

FIG. 59 is a hook portion of the hook and loop mounting tape

FIG. 60 is an adhesive heel guard.

FIG. 61 is an adhesive decubitus ulcer avoidance pad.

FIG. 62 is an adhesive amputee stump sleeve.

FIG. 63 is an adhesive corn remover strip CORN.

FIG. 64 is an adhesive callus cushion.

FIG. 65 is an adhesive gel toe separator.

FIG. 66 is an adhesive ball blister cushion.

FIG. 67 is an adhesive heel blister cushion.

FIG. 68 is an adhesive toe blister cushion.

FIG. 69 is an adhesive bunion cushion.

FIG. 70 is another embodiment of the adhesive bunion cushion.

FIG. 72 is another embodiment of the adhesive bunion cushion.

FIG. 73 is an exfoliating foot peel

FIG. 74 is an adhesive breast pump interface.

FIG. 75 is a flexible magnetic tape.

FIG. 76 is a flexible magnetic sheet.

FIG. 77 is a cord or cloth tie attachment

### DETAILED DESCRIPTION OF THE INVENTION

This invention relates to thick, re-attachable, ultra-low modulus adhesive films of at least one mil in thickness that release from a surface by adhesive failure, not a cohesive failure. They are tacky to the touch and cleanly peel from the skin yet retain exceptional adhesive qualities to a wide variety of materials. These have a soft feel, which makes them eminently suitable for skin-contact applications.

The solid-phase adhesives comprise films of at least one mil thick. They include a substantially homogeneous mixture containing, based on 100% of the weight of the solids of the solid-phase adhesive:
(i) At least 20 weight % of a low molecular weight resin resulting from the polymerization and hydrogenation of styrenic monomer feedstock having a ring and ball softening point of about 10°−45° C. In certain embodiments, the concentration of the low molecular weight resin in the solid-phase adhesive is between about 70 weight % and about 95 weight %.
(ii) From about 2 to about 40 weight % of a triblock copolymer with a saturated elastomeric block in the center and a thermoplastic block on each end alone or in combination with a diblock copolymer of a hard-thermoplastic block and a saturated, soft ethylene-butylene polymeric block.
(iii) The balance being one or more oily liquids comprising butyloctanol, C12, C12-17, C14-22, caprylic/capric triglyceride, coco-caprylate, cocoyl adipic acid/trimethylolpropane copolymer, 1,2-cyclohexane dicarboxylic acid diisononyl ester, butyl stearate, dicaprylyl ether, diethylhexyl sebacate, diisobutyl adipate, diisostearyl fumarate, diisostearyl malate, dimerdiol-carbonate, dodecane, hexyldecanol, hydrogenated poly(C6-14 olefin), hydrogenated polydecine, isononyl isononanoate, isopropyl shea butterate (and) dodecane (and) hexadecane, isostearyl isostearate, isostearyl lactate, lauryl lactate, lauryl lactyl lactate, neopentyl glycol diethylhexanoate, octyldodecanol, octyldodecyl lactate, octyldodecyl stearate, octyldodecyl stearoyl stearate, oleyl alcohol, oleyl erucate, oleyl lactate, PEG/PPG-8/3 diisostearate, polybutene, PPG-26/dimer dilinoleate copolymer (and) isononyl isononanoate (and) ethylhexyl isononanoate, propylene glycol dicaprylate/dicaprate, propylheptyl caprylate, triisostearyl citrate, undecane (and) tridecane, esters typically used in cosmetics, liquid hydrocarbon polymers, or hydrogenated liquid hydrocarbon polymers. In certain embodiments, the concentration of the hydrophobic liquid in the solid-phase adhesive is between about 1 weight % and about 15 weight %.

The solid-phase adhesives might also contain up to 80% hydrocolloid added to the above mixture. The hydrocolloids are immiscible in the solid-phase adhesive compositions but may be suspended in powder form. The hydrocolloids might absorb moisture if present.

Aside from any hydrocolloids, the most significant component of the solid-phase adhesive film composition of the invention, on a solids weight basis, is typically the low molecular weight resin produced by the polymerization and hydrogenation of a styrenic monomer feedstock, having a ring and ball softening point of about 10°−45° C., preferably a ring and ball softening point of about 4°−25° C. and a low weight average molecular weight below about 550, typically below about 500, and usually above about 330. The resins are desirably liquids at room temperature, about 23° C. The resins fulfilling these qualifications are commercially available as REGALREZ 1018 and 1033. Details of their compositions and physical properties are set forth above. They can be used alone or in combination. The preferred resin is REGALREZ 1018. The preferred resin has a weight average molecular weight between about 375 and 430. For example, a smaller amount of REGALREZ 1033, up to about 40 weight % of the resin composition, on a solid-state basis, can be incorporated into the adhesive film formulation. An exceptional feature of the invention is the uniquely high concentration in the solid-phase adhesive film composition of these low molecular weight resins.

When it became evident that people needed better facemasks to prevent the spread of infectious diseases such as Covid-19, David Sieverding added seals to some facemasks made from the gel-appearing adhesives of U.S. Pat. No. 4,833,193. For this experiment, Mr. Sieverding used Example 1, Formulation 1, from this patent. This adhesive contained 5% KRATON-1651, 9% mineral oil (300 Saybolt Seconds viscosity), and 86% REGALREZ 1018.

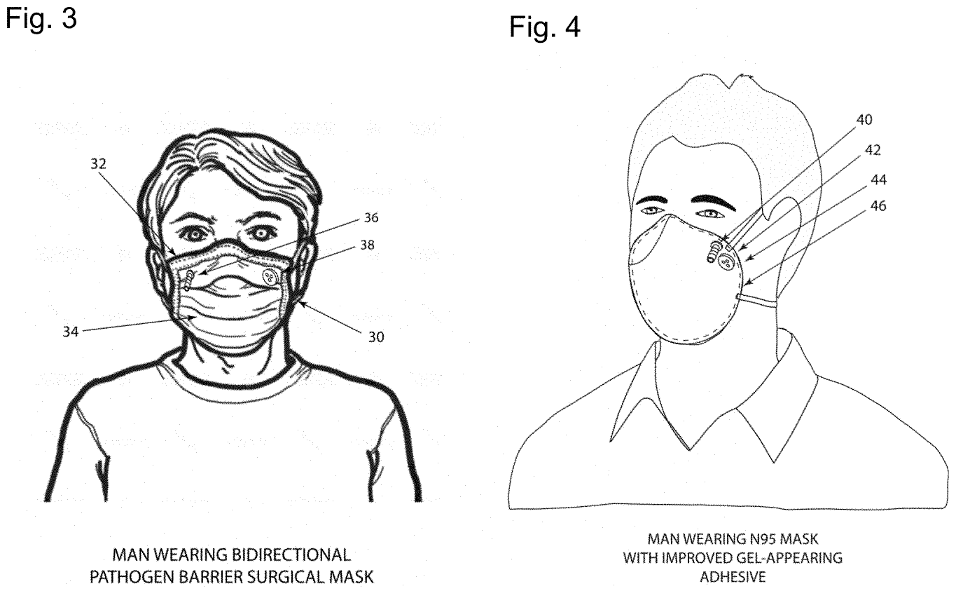

Mr. Sieverding made facemasks with a seal made from this formulation, as shown in FIGS. 2 and 3. Mr. Sieverding wore these many times to determine whether he could improve them. Mr. Sieverding concluded that the adhesive was acceptable but that an even lower modulus adhesive would be more desirable. A more elastic, less viscoelastic adhesive would also be more desirable. So, he decided to experiment to see if substituting another hydrophobic material for the mineral oil would decrease the modulus and result in a more elastic, less viscoelastic adhesive.

Mr. Sieverding tried substituting many different hydrophobic liquids for the mineral oil. Surprisingly, he discovered that 47 of these hydrophobic liquids produced acceptable results, although some were more acceptable than others. He tried them at use levels up to 40%.

As compared to the pressure-sensitive adhesives disclosed in U.S. Pat. No. 4,833,193; these experimental results demonstrated that one could formulate the solid-phase adhesives to have a significantly higher level of stretchiness (or significantly lower Young's modulus) and higher elasticity (less viscoelasticity). This higher level of stretchiness and elasticity can permit even more comfortable movement when wearing devices incorporating the gel-appearing adhesive on human skin. In certain embodiments, the Young's modulus of the solid-phase adhesive is less than about 2 psi.

This particularly true of those based on the lower molecular weight alkanes, ethers, and esters listed, as well as low molecular polyalphaolefin and hydrogenated polyalphaolefin such as, but not limited to, ExxonMobil's Puresyn 2 hydrogenated Poly (C6-14 olefin) also known as polyalphaolefin.

I listed these results, for example, Sets 1, 2, 3 & 4. These example sets have progressively increasing hydrophilic liquids' levels added to mixtures of KRATON G1651 and REGALREZ 1018. As the amount of these third ingredients goes up, Young's modulus tends to go down. Changing the added hydrophilic liquid also results in differences in the resulting Young's modulus.

In general, the lower viscosity, lower molecular weight added hydrophobic liquids produced a more aesthetically pleasing result.

### Experiment Set One

In this set of examples, 2.5% of the oily liquid listed in columns 1 and 2 is combined with a molten adhesive consisting of 5% KRATON G 1651 and 95% REGALREZ 1018, stirred and allowed to cool to form a new adhesive.

As compared to the mixture containing 5% KRATON G 1651 and 95% REGALREZ 1018, the resulting materials have better adhesive properties for use on human skin. The improved adhesives leave less residue, if any, on the skin upon removal. The improved adhesives have greater elongation before separating from the skin, often several times greater elongation. The resulting adhesives have lower Young's moduli (greater elasticity). The resulting adhesives have better recovery from strain, less pulling of hair, and less MARSI when removed from the skin. The three-component mixtures' properties tend to improve more when the added oily liquid has a low viscosity. For example, the mineral oil, Iris (C12-17 Alkanes), used in these experiments has a kinematic viscosity of 3.58 cSt (which is less viscous than milk at 4.3 cSt). In comparison, the mineral oil typically used in the manufacture of KRATON-based thermoplastic elastomers has a kinematic viscosity of 66-75 cSt (which is more viscous than vegetable oil at 43.2 cSt). Higher viscosity mineral oil tends to have a slower evaporation rate, while lower viscosity mineral oil tends to have the advantage of producing lower modulus adhesives.

EXPERIMENT SET ONE - HOMOGENOUS FORMULAE
(2.5% INGREDIENT ADDED)

| Trade Name | Chemical Name | Supplier |
|---|---|---|
| BST-COS | Butyl Stearate | Hallstar |
| Ceraphyl 847 | Octyldodecyl Stearoyl Stearate | Ashland |
| Ceraphyl ODS | Octyldodecyl Stearate | Ashland |
| Cetiol C 5 | Coco-Caprylate | BASF |
| Cetiol Ultimate | Undecane (and) Tridecane | BASF |
| Cosmedia DC | Dimerdiol-Carbonate | BASF |
| DOS | Diethylhexyl Sebacate | Hallstar |
| Eutanol G | Octyldodecanol | BASF |
| Halltress DIBA | Diisobutyl Adipate | Hallstar |
| SPECIAL | | |
| Hexamoll DINCH | 1,2-Cyclohexane dicarboxylic | BASF |
| | acid diisononyl ester | |
| Iris | C12-17 | |
| ISOFOL 12 | Isostearyl Isostearate | Sasol |
| Isofol 16 | Cocoyl Adipic Acid/Trimethylol- | Sasol |
| | propane Copolymer | |
| Isofol 20 | Butyloctanol | Sasol |
| Jarcane 12 | dodecane | Jarchem |
| Jarcol 95CG | Oleyl Alcohol | Jarchem |
| Jarether D8 | Dicaprylyl Ether | Jarchem |
| Jarplex MUR | Isopropyl Shea Butterate (and) | Jarchem |
| | Dodecane (and) Hexadecane | |
| Lilac | C14-22 | Sonneborn |
| Pelemol 0DL | Octyldodecyl Lactate | Phoenix |
| Pelemol BIP-PC | Butylphthalimide (and) Isopropyl- | Phoenix |
| | phthalimide | |
| Pelemol D-899 | PPG-26/Dimer Dilinoleate Co- | Phoenix |
| | polymer (and) Isononyl | |
| | Isononanoate (and) Ethylhexyl | |
| | Isononanoate | |
| Pelemol IN-2 | Isononyl Isononanoate | Phoenix |
| Pelemol ISL | Isostearyl Lactate | Phoenix |
| Pelemol LL | Lauryl Lactate | Phoenix |
| Pelemol NGDO | Neopentyl Glycol Diethylhexanoate | Phoenix |
| Pelemol ODL | Octyldodecyl Lactate | Phoenix |
| Pelemol PDD | Propylene Glycol Dicaprylate/ | Phoenix |
| | Dicaprate | |
| Permethyl HPIB-6 | Hydrogenated Polyisobutene | Presperse |
| Puresyn 2 | Hydrogenated Poly(C6-14 Olefin) | ExxonMobil |
| Puresyn 4 | Hydrogenated Poly(C6-14 Olefin) | ExxonMobil |
| Puresyn 6 | Hydrogenated Poly(C6-14 Olefin) | ExxonMobil |
| Schercemol | Cocoyl Adipic Acid/Trimethylol- | Lubrizol |
| CATC ester | propane Copolymer | |

### Experiment Set Two

In this set of examples, 5% of the ingredient listed in column 2 is combined with a molten mixture containing 5% KRATON G 1651 and 95% REGALREZ 1018, stirred and allowed to cool, resulting in both usable adhesives and unusable materials.

EXPERIMENT SET TWO - HOMOGENOUS FORMULAE
(5% INGREDIENT ADDED)

| Trade Name | Chemical Name | Supplier |
|---|---|---|
| BST-COS | Butyl Stearate | Hallstar |
| Ceraphyl 847 | Octyldodecyl Stearoyl Stearate | Ashland |
| Ceraphyl ODS | Octyldodecyl Stearate | Ashland |
| Cetiol C 5 | Coco-Caprylate | BASF |
| Cetiol Ultimate | Undecane (and) Tridecane | BASF |
| Cosmedia DC | Dimerdiol-Carbonate | BASF |
| DOS | Diethylhexyl Sebacate | Hallstar |
| Eutanol G | Octyldodecanol | BASF |
| Halltress DIBA | Diisobutyl Adipate | Hallstar |
| SPECIAL | | |
| Hexamoll DINCH | 1,2-Cyclohexane dicarboxylic | BASF |
| | acid diisononyl ester | |
| Iris | C12-17 | |
| ISOFOL 12 | Isostearyl Isostearate | Sasol |
| Isofol 16 | Cocoyl Adipic Acid/Trimethylol- | Sasol |
| | propane Copolymer | |
| Isofol 20 | Butyloctanol | Sasol |
| Jarcane 12 | dodecane | Jarchem |
| Jarcol 95CG | Oleyl Alcohol | Jarchem |
| Jarether D8 | Dicaprylyl Ether | Jarchem |
| Jarplex MUR | Isopropyl Shea Butterate (and) | Jarchem |
| | Dodecane (and) Hexadecane | |
| Lilac | C14-22 | Sonneborn |
| Pelemol 0DL | Octyldodecyl Lactate | Phoenix |
| Pelemol BIP-PC | Butylphthalimide (and) Isopropyl- | Phoenix |
| | phthalimide | |
| Pelemol D-899 | PPG-26/Dimer Dilinoleate Co- | Phoenix |
| | polymer (and) Isononyl | |
| | Isononanoate (and) Ethylhexyl | |
| | Isononanoate | |
| Pelemol IN-2 | Isononyl Isononanoate | Phoenix |
| Pelemol ISL | Isostearyl Lactate | Phoenix |
| Pelemol LL | Lauryl Lactate | Phoenix |
| Pelemol NGDO | Neopentyl Glycol Diethylhexanoate | Phoenix |
| Pelemol ODL | Octyldodecyl Lactate | Phoenix |
| Pelemol PDD | Propylene Glycol Dicaprylate/ | Phoenix |
| | Dicaprate | |
| Permethyl HPIB-6 | Hydrogenated Polyisobutene | Presperse |
| Puresyn 2 | Hydrogenated Poly(C6-14 Olefin) | ExxonMobil |
| Puresyn 4 | Hydrogenated Poly(C6-14 Olefin) | ExxonMobil |
| Puresyn 6 | Hydrogenated Poly(C6-14 Olefin) | ExxonMobil |
| Schercemol | Cocoyl Adipic Acid/Trimethylol- | Lubrizol |
| CATC ester | propane Copolymer | |

EXPERIMENT SET TWO - SEPARATING FORMULAE
(5% ADDED INGREDIENT)

| Trade Name | Chemical Name | Supplier |
|---|---|---|
| Schercemol DISF ester | Diisostearyl Fumarate | Lubrizol |
| Schercemol DISM ester | Diisostearyl Malate | Lubrizol |
| Schercemol NGDO ester | Neopentyl Glycol | Lubrizol |
| | Diethylhexanoate | |
| Schercemol TISC ester | Triisostearyl Citrate | Lubrizol |
| Stepan MILD L3 | Lauryl Lactyl Lactate | Stepan |

### Experiment Set Three

In this set of examples, 10% of the ingredient listed in column 2 is combined with a molten mixture containing 5% KRATON G 1651 and 95% REGALREZ 1018, stirred and allowed to cool, resulting in both usable adhesives and unusable materials.

EXPERIMENT SET THREE - HOMOGENOUS FORMULAE
(10% ADDED INGREDIENT)

| Trade Name | Chemical Name | Supplier |
|---|---|---|
| Ceraphyl 847 | Octyldodecyl Stearoyl Stearate | Ashland |
| Ceraphyl ODS | Octyldodecyl Stearate | Ashland |
| Cetiol C 5 | Coco-Caprylate | BASF |
| Cetiol J 600 | Oleyl Erucate | BASF |
| Cetiol Sensoft | Propylheptyl Caprylate | BASF |
| Cetiol Ultimate | Undecane (and) Tridecane | BASF |
| Cosmedia DC | Dimerdiol-Carbonate | BASF |
| Eutanol G | Octyldodecanol | BASF |
| HALLSTAR BST-COS | Butyl Stearate | Hallstar |
| HALLSTAR DOS | Diethylhexyl Sebacate | Hallstar |
| Halltress DIBA | Diisobutyl Adipate | Hallstar |
| SPECIAL | | |
| Hexamoll DINCH | 1,2-Cyclohexane dicarboxylic | BASF |
| | acid diisononyl ester | |
| Hydramol PGPD ester | PEG/PPG-8/3 Diisostearate | Lubrizol |
| Indopol H1200 | polybutene | Ineos |
| Iris | C12-17 | Sonneborn |
| isododecane | C12 | generic |
| ISOFOL 12 | Butyloctanol | Sasol |
| Isofol 16 | Hexyl decanol | Sasol |
| Isofol 20 | Octyldodecanol | Sasol |
| Jarcane 12 | dodecane | Jarchem |
| Jarcol 95CG | Oleyl Alcohol | Jarchem |
| Jarether D8 | Dicaprylyl Ether | Jarchem |
| Jarplex MUR | Isopropyl Shea Butterate (and) | Jarchem |
| | Dodecane (and) Hexadecane | |
| Lilac | C14-22 | Sonneborn |
| Myritol 312 | Caprylic/Capric Triglyceride | BASF |
| Pelemol BIP-PC | Butylphthalimide (and) Isopropyl- | Phoenix |
| | phthalimide nanoate | |
| Pelemol D-899 | PPG-26/Dimer Dilinoleate Co- | Phoenix |
| | polymer (and) Isononyl | |
| | Isononanoate (and) Ethylhexyl | |
| | Isononanoate | |
| Pelemol IN-2 | Isononyl Isononanoate | Phoenix |
| Pelemol ISL | Isostearyl Lactate | Phoenix |
| Pelemol LL | Lauryl Lactate | Phoenix |
| Pelemol NGDO | Neopentyl Glycol Diethyl- | Phoenix |
| | hexanoate | |
| Pelemol ODL | Octyldodecyl Lactate | Phoenix |
| Pelemol ODL | Octyldodecyl Lactate | Phoenix |
| Pelemol OL | Oleyl Lactate | Phoenix |
| Pelemol PDD | Propylene Glycol Dicaprylate/ | Phoenix |
| | Dicaprate | |
| Permethyl HPIB-6 | viscous polymer | Presperse |
| Puresyn 2 | Hydrogenated Poly(C6-14 Olefin) | Exxon |
| Puresyn 4 | Hydrogenated Poly(C6-14 Olefin) | Exxon |
| Puresyn 6 | Hydrogenated Poly(C6-14 Olefin) | Exxon |
| Schercemol 1818 ester | Isostearyl Isostearate | Lubrizol |
| Schercemol CATC ester | Cocoyl Adipic Acid/Trimethylol- | Lubrizol |
| | propane Copolymer | |
| Schercemol DISF ester | Diisostearyl Fumarate | Lubrizol |
| Schercemol DISM ester | Diisostearyl Malate | Lubrizol |
| Schercemol NGDO ester | Neopentyl Glycol Diethyl- | Lubrizol |
| | hexanoate | |
| Schercemol TISC ester | Triisostearyl Citrate | Lubrizol |
| Silkflo 366 | hydrogenated Polydecine | Vantage |
| Silkflow 364 | hydrogenated Polydecine | Vantage |
| STEPAN-MILD L3 | Lauryl Lactyl Lactate | Stepan |

EXPERIMENT SET THREE - SEPARATING FORMULAE
(10% INGREDIENT ADDED)

| Trade Name | Chemical Name | Supplier |
|---|---|---|
| Cetiol J 600 | Oleyl Erucate | BASF |
| Coscap G7-MC | Glycereth-7 Trimethyl | Phoenix Chemical |
| | Ether | |
| Cutina CP | Cetyl Palmitate | BASF |
| Cutina PES | Pentaerythrityl Distearate | BASF |
| Dermasoft Hexiol | 1,2-Hexanediol | Evonik Dr. |
| | | Straetmans GmbH |
| DUB PTO | Pentaerythrityl | Stearineriw Dubois |
| | Tetraethylhexanoate | |
| Floramac 10 | Ethyl Macadamiate | Floratech |
| Ganex V-216 | VP/Hexadecene Copolymer | Ashland |
| GLUCAM P-20 | PPG-20 Methyl Glucose | Lubrizol |
| DISTEARATE | Ether Distearate | |
| Indopol H6000 | polybutene | Ineos Oligomers |
| Lameform TGI | Polyglyceryl-3 Diisostearate | BASF |
| Lanette 22 | Behenyl Alcohol | BASF |
| Lipex Sheaclear | Shea Oil | AAK |
| Parleam HV | hydrogenated polybutene | NOF Corporation |
| Parleam V | hydrogenated polybutene | NOF Corporation |
| Pelemol 1215 | C12-15 Alkyl Lactate | Phoenix Chemical |
| Pelemol DIA | Diisopropyl Adipate | Phoenix Chemical |
| Pelemol G-7A | Glycereth-7 Triacetate | Phoenix Chemical |
| Pelemol BIP-PC | Butylphthalimide (and) | Phoenix Chemical |
| | Isopropylphthalimide | |
| Pelemol D9336 | Diisopropyl Dimer | Phoenix Chemical |
| | Dilinoleate | |
| Pelemol GTIS | Triisostearin | Phoenix Chemical |
| Pelemol ICB | Isocetyl Behenate | Phoenix Chemical |
| Pelemol OL | Oleyl Lactate | Phoenix Chemical |
| Pelemol P-49 | Pentaerythrityl | Phoenix Chemical |
| | Tetraisononanoate | |
| Pelemol TMPIS | Trimethylolpropane | Phoenix Chemical |
| | Triisostearate | |
| Performa 825 | hyper-branched | New Phase |
| | polyalphaolefin | |
| Schercemol DISD | Diisostearyl Dimer | Lubrizol |
| ester | Dilinoleate | |
| Schercemol PTID | Triisostearoyl | Lubrizol |
| ester | Polyglyceryl-3 Dimer | |
| | Dilinoleate | |
| SCHEREMOL 105 | Neopentanoate | Lubrizol |
| ESTER | | |
| SCHEREMOL DIA | Diisopropyl Adipate | Lubrizol |
| ESTER | | |
| Varisoft BT 85 | Behentrimonium Chloride | Evonik |
| Pellets J | | |

### Experiment Set Four

In this set of examples, 20% of the ingredient listed in column 2 is combined with a molten mixture containing 8% KRATON G 1651 and 92% REGALREZ 1018, stirred and allowed to cool, resulting in both usable adhesives and unusable materials.

EXPERIMENT SET FOUR - HOMOGENOUS FORMULAE
(20% INGREDIENT ADDED)

| Trade Name | Chemical Name | Supplier |
|---|---|---|
| Ceraphyl 847 | Octyldodecyl Stearoyl Stearate | Ashland |
| Ceraphyl ODS | Octyldodecyl Stearate | Ashland |
| Cetiol C 5 | Coco-Caprylate | BASF |
| Cetiol J 600 | Oleyl Erucate | BASF |
| Cetiol Sensoft | Propylheptyl Caprylate | BASF |
| Cetiol Ultimate | Undecane (and) Tridecane | BASF |
| Hallstar DOS | Diethylhexyl Sebacate | Hallstar |
| Hexamoll DINCH | 1,2-Cyclohexane dicarboxylic | BASF |
| | acid diisononyl ester | |
| Iris | C12-17 | Sonneborn |
| Isododecane | C12 | generic |
| Isofol 20 | Octyldodecanol | Sasol |
| Jarcane 12 | dodecane | Jarchem |
| Jarcol 95CG | Oleyl Alcohol | Jarchem |
| Jarether D8 | Dicaprylyl Ether | Jarchem |
| Jarplex MUR | Isopropyl Shea Butterate (and) | Jarchem |
| | Dodecane (and) Hexadecane | |
| Lilac | C14-22 | Sonneborn |
| Myritol 312 | Caprylic/Capric Triglyceride | BASF |
| Pelemol IN-2 | Isononyl Isononanoate | Phoenix |
| Pelemol ISL | Isostearyl Lactate | Phoenix |
| Pelemol LL | Lauryl Lactate | Phoenix |
| Pelemol OL | Oleyl Lactate | Phoenix |
| Permethyl HPIB-6 | viscous polymer | Presperse |
| Puresyn 2 | Hydrogenated Poly(C6-14 Olefin) | Exxon |
| Puresyn 4 | Hydrogenated Poly(C6-14 Olefin) | Exxon |
| Puresyn 6 | Hydrogenated Poly(C6-14 Olefin) | Exxon |
| Schercemol 1818 | Isostearyl Isostearate | Lubrizol |
| Ester | | |
| Schercemol DISF | Diisostearyl Fumarate | Lubrizol |
| Ester | | |
| Schercemol DISM | Diisostearyl Malate | Lubrizol |
| Ester | | |
| Schercemol TISC | Triisostearyl Citrate | Lubrizol |
| Ester | | |
| Silkflo 366 | hydrogenated Polydecine | Vantage |
| Silkflow 364 | hydrogenated Polydecine | Vantage |

EXPERIMENT SET FOUR - SEPARATING FORMULAE
(20% INGREDIENT ADDED)

| Trade Name | Chemical Name | Supplier |
|---|---|---|
| Cosmedia DC | Dimerdiol-Carbonate | BASF |
| HALLSTAR BST- | Butyl Stearate | Hallstar |
| COS | | |
| Halltress DIBA | Diisobutyl Adipate | Hallstar |
| SPECIAL | | |
| Hydramol PGPD | PEG/PPG-8/3 Diisostearate | Lubrizol |
| ester | | |
| Hydramol PGPD | PEG/PPG-8/3 Diisostearate | Lubrizol |
| ester | | |
| Indopol H1200 | polybutene | Ineos Oligomers |
| ISOFOL 12 | Butyloctanol | Sasol Performance |
| | | Chemicals |
| ISOFOL 16 | Hexyldecanol | Sasol Performance |
| | | Chemicals |
| Myritol 312 | Caprylic/Capric Triglyceride | BASF |
| Pelemol BIP-PC | PPG-26/Dimer Dilinoleate | Phoenix Chemical |
| | Copolymer (and) Isononyl | |
| | Isononanoate (and) | |
| | Ethylhexyl Isononanoate | |
| Pelemol D-899 | PPG-26/Dimer Dilinoleate | Phoenix Chemical |
| | Copolymer (and) Isononyl | |
| | Isononanoate (and) | |
| | Ethylhexyl Isononanoate | |
| Pelemol NGDO | Neopentyl Glycol | Phoenix Chemical |
| | Diethylhexanoate | |
| Pelemol PDD | Propylene Glycol | Phoenix Chemical |
| | Dicaprylate/Dicaprate | |
| Schercemol CATC | Cocoyl Adipic Acid/ | Lubrizol |
| ester | Trimethylolpropane | |
| | Copolymer | |
| Schercemol NGDO | Neopentyl Glycol | Lubrizol |
| ester | Diethylhexanoate | |
| STEPAN-MILD L3 | Lauryl Lactyl Lactate | Stepan |
| Halltress DIBA | Diisobutyl Adipate | Hallstar |
| SPECIAL | | |
| HALLSTAR BST- | Butyl Stearate | Hallstar |
| COS | | |
| Pelemol ODL | Octyldodecyl Lactate | Phoenix Chemical |
| Pelemol BIP-PC | PPG-26/Dimer Dilinoleate | Phoenix Chemical |
| | Copolymer (and) Isononyl | |
| | Isononanoate (and) | |
| | Ethylhexyl Isononanoate | |
| Pelemol D-899 | PPG-26/Dimer Dilinoleate | Phoenix Chemical |
| | Copolymer (and) Isononyl | |
| | Isononanoate (and) | |
| | Ethylhexyl Isononanoate | |
| Pelemol PDD | Propylene Glycol | Phoenix Chemical |
| | Dicaprylate/Dicaprate | |
| Pelemol 0DL | Propylene Glycol | Phoenix Chemical |
| | Dicaprylate/Dicaprate | |
| Pelemol NGDO | Neopentyl Glycol | Phoenix Chemical |
| | Diethylhexanoate | |
| STEPAN-MILD L3 | Lauryl Lactyl Lactate | Stepan |

### Experiment Five Six

In this set of examples, 40% of the ingredient listed in column 2 is combined with a molten mixture containing 8% KRATON G 1651 and 92% REGALREZ 1018, stirred and allowed to cool, resulting in both usable adhesives and unusable materials.

EXPERIMENT SET FIVE - HOMOGENOUS FORMULAE
(40% INGREDIENT ADDED)

| Trade Name | Chemical Name | Supplier |
|---|---|---|
| Ceraphyl ODS | Octyldodecyl Stearate | Ashland |
| Cetiol Ultimate | Undecane (and) Tridecane | BASF |
| Hexamoll DINCH | 1,2-Cyclohexane dicarboxylic | BASF |
| | acid diisononyl ester | |
| Iris | C12-17 | Sonneborn |
| Isododecane | C12 | Generic |
| Isofol 20 | Octyldodecanol | Sasol |
| Jarcane 12 | dodecane | Jarchem |
| Jarether D8 | Dicaprylyl Ether | Jarchem |
| Jarplex MUR | Isopropyl Shea Butterate (and) | Jarchem |
| | Dodecane (and) Hexadecane | |
| Myritol 312 | Caprylic/Capric Triglyceride | BASF |
| Permethyl HPIB-6 | viscous polymer | Presperse |
| Puresyn 2 | Hydrogenated Poly(C6-14 Olefin) | Exxon |
| Puresyn 4 | Hydrogenated Poly(C6-14 Olefin) | Exxon |
| Puresyn 6 | Hydrogenated Poly(C6-14 Olefin) | Exxon |
| Schercemol | Diisostearyl Malate | Lubrizol |
| DISM ester | | |
| Silkflo 364 | hydrogenated Polydecine | Vantage |
| Silkflo 366 | hydrogenated Polydecine | Vantage |

EXPERIMENT SET FIVE - SEPARATING FORMULAE
(40% INGREDIENT ADDED)

| Trade Name | Chemical Name | Supplier |
|---|---|---|
| Ceraphyl 847 | Octyldodecyl Stearoyl Stearate | Ashland |
| Cetiol C 5 | Coco-Caprylate | BASF |
| Cetiol J 600 | Oleyl Erucate | BASF |
| Cetiol Sensoft | Propylheptyl Caprylate | BASF |
| Jarcol 95CG | Oleyl Alcohol | Jarchem |
| Lilac | C14-22 | Sonneborn |
| Panalane L14E | hydrogenated Polyisobutylene | Vantage |
| Pelemol OL | Oleyl Lactate | Phoenix |
| | | Chemical |
| Pelemol IN-2 | Isononyl Isononanoate | Phoenix |
| | | Chemical |
| Pelemol ISL | Isostearyl Lactate | Phoenix |
| | | Chemical |
| Pelemol LL | Lauryl Lactate | Phoenix |
| | | Chemical |
| Schercemol 1818 ester | Isostearyl Isostearate | Lubrizol |
| Schercemol DISF ester | Diisostearyl Fumarate | Lubrizol |
| Schercemol TISC ester | Triisostearyl Citrate | Lubrizol |

This set of experiments resulted in the surprising discovery that it is possible to make a highly superior adhesive for attaching devices to human skin by compounding 1) a low-softening-point, high-viscosity cycloaliphatic hydrocarbon resin produced by polymerization and hydrogenation of hydrocarbon feedstocks, such as REGALREZ 1018, 2) an oily liquid such, but not limited to, 1,2-Cyclohexane dicarboxylic acid diisononyl ester, Butyl Stearate, Butyloctanol, Butylphthalimide (and) Isopropylphthalimide, C12-17, C14-22, Coco-Caprylate, Cocoyl Adipic Acid/Trimethylolpropane Copolymer, Cocoyl Adipic Acid/Trimethylolpropane Copolymer, Dicaprylyl Ether, Diethylhexyl Sebacate, Diisobutyl Adipate, Dimerdiol-Carbonate, dodecane, Hydrogenated Poly(C6-14 Olefin), Hydrogenated Poly(C6-14 Olefin), Hydrogenated Poly(C6-14 Olefin), Hydrogenated Polyisobutene, Isononyl Isononanoate, Isopropyl Shea Butterate (and) Dodecane (and) Hexadecane, Isostearyl Isostearate, Isostearyl Lactate, Lauryl Lactate, Neopentyl Glycol Diethylhexanoate, Octyldodecanol, Octyldodecyl Lactate, Octyldodecyl Lactate, Octyldodecyl Stearate, Octyldodecyl Stearoyl Stearate, Oleyl Alcohol, PPG-26/Dimer Dilinoleate Copolymer (and) Isononyl Isononanoate (and) Ethylhexyl Isononanoate, Propylene Glycol Dicaprylate/Dicaprate, or Undecane (and) Tridecane and 3) a high molecular weight styrene-ethylene/butylene-styrene block such as KRATON G1651 at elevated temperatures, typically around 200-350° Fahrenheit.

Without the oily liquid, a compound of the low-softening-point, high viscosity cycloaliphatic hydrocarbon resin produced by polymerization and hydrogenation of hydrocarbon feedstocks, such as REGALREZ 1018 and a high molecular weight styrene-ethylene/butylene-styrene block such as KRATON G1651 mixed at elevated temperatures, around 200-350° Fahrenheit, typically has adhesive properties but tends to be harsh to the skin and hair when it is applied to and removed from them. It also tends to lose some of its adhesivity after being applied to and removed from the skin. Although primarily exhibiting solid behavior, it also tends to exhibit some viscous flow behavior.

These experiments show that even adding as little as 5% of an oily liquid, such as but not limited to, one of the above-listed oily liquids, to a molten mixture containing 5% KRATON G1651 and 95% REGALREZ 1018 and then allowing that mixture to cool can result in compounds with dramatically lower Young's moduli as compared to the same formulae without the oily liquid. When applied to human skin, this translates into greater comfort while wearing and removing devices coated with the adhesive and much greater re-attachability of those devices.

The ultra-low-modulus solid-phase adhesives extend the range of stretchiness, the lower bounds of Young's modulus, beyond those listed in U.S. Pat. No. 4,833,193. As a result of the lower Young's modulus, the solid-phase adhesive provides an improvement over the gel-appearing adhesives disclosed in U.S. Pat. No. 4,833,193.

Owing to their hydrophobic nature, for some applications, the ultra-low-modulus solid-phase adhesives also have advantages over the hydrophilic, elastomeric, pressure-sensitive adhesive disclosed in U.S. Pat. No. 4,699,146 and the hydrophilic, elastomeric, pressure-sensitive adhesive disclosed in U.S. Pat. No. 4,750,482. These advantages include being hydrophobic instead of hydrophilic and not requiring an expensive electron beam to form the adhesive.

The adhesives disclosed in U.S. Pat. Nos. 4,699,146 and 4,750,482 contain both water and electrolyte to make them conductive for their intended use in medical electrodes.

As a result of higher elasticity, the solid-phase adhesive also provides an improvement over the gel-appearing adhesives disclosed in U.S. Pat. No. 4,833,193. This improvement is especially significant when using the gel-appearing adhesives in applications that involve affixing a device to the human body. The improved gel-appearing adhesives disclosed in this patent are valuable for many applications. These applications include medical, personal care, fashion, military, remote sensing, virtual reality, control, telemetry, gaming, and communications applications. Still, this statement does not limit these gel-appearing adhesives' usefulness to these applications.

The ultra-low modulus solid-phase adhesives have a thickness greater than about one mil, desirably greater than about four mils, more desirably greater than about eight mils, preferably greater than about 12 mils, and most preferably, greater than about 20 mils.

The ultra-low-modulus solid-phase adhesive films function as thick films with the following advantages.
(1) They are solids.
(2) They are re-attachable.
(3) They can possess a soft tactility.
(4) They do not cause skin trauma.
(5) They do not cause hair trauma.
(6) They span a wide variety of useful applications.
(7) They are stable materials.
(8) Some release cleanly from themselves.
(9) Some can be folded back on themselves, stick to themselves, yet separate from themselves, recovering to their original shape.
(10) They feel more supple to the touch, especially those made with alkanes in the range of C12-C20, ethers, esters, low molecular weight polymers, such as Puresyn 2 hydrogenated Poly(C6-14 olefin) from Exxon.

These experiments show a wide range of ultra-low-modulus solids with solid-phase adhesive properties. All of the ultra-low-modulus, solid-state adhesives described herein and all of those that fall within the scope of U.S. Pat. No. 4,833,193 can be mixed with hydrocolloids to enable them to absorb water that may arise from perspiration, wound drainage, and other bodily fluids.

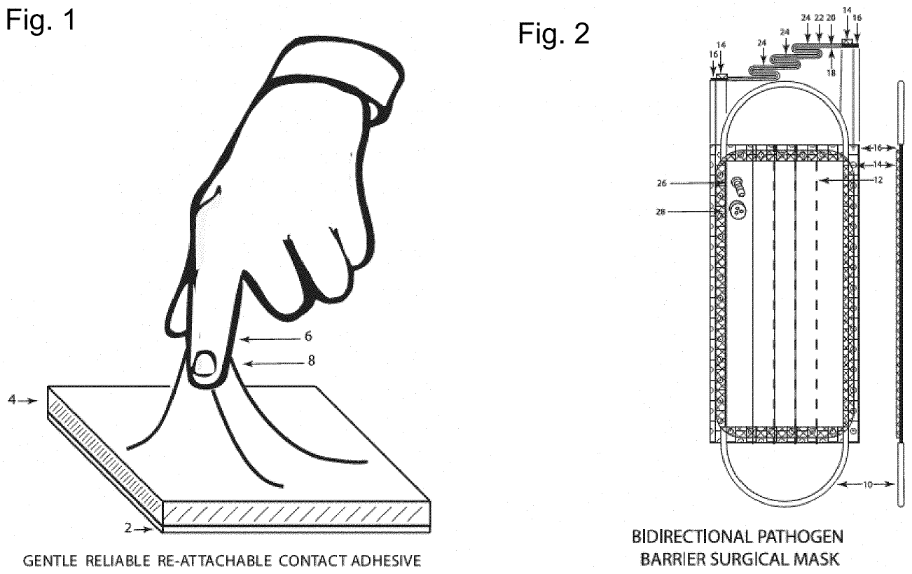

FIG. 1 shows stretching of a solid-phase adhesive according to an embodiment of the invention. The extremely low Young's modulus of the solid-phase adhesive makes very high levels of strain possible. 2 is a substrate coated with the extremely low Young's modulus solid-phase adhesive. 4 is the extremely low Young's modulus solid-phase adhesive. 6 is a finger that has touched the adhesive and been lifted. 8 is the solid-phase adhesive that has stretched considerably while not losing its adhesion. The solid-phase adhesive might have up to 80% added hydrocolloids to absorb moisture such as perspiration.

FIG. 2 shows an adhesive bidirectional pathogen barrier surgical mask. This face mask filters both inhaled and exhaled air. 10 is the optional side straps (The side straps are not needed because the solid-phase adhesive holds the mask on, but they may exist if one makes the adhesive bidirectional pathogen barrier surgical face mask by modifying a surgical mask). 12 is one of 6 folds in a standard surgical mask. 14 is a layer of solid-phase adhesive with up to 80% added hydrocolloids to absorb moisture such as perspiration. 16 is the fused area of the surgical face mask. 18 is the innermost nonwoven fabric layer. 20 is the outermost nonwoven fabric layer. 22 is the filter layer. 24 is the three pleats. 26 is an optional oxygen fitting. 28 is an optional oximeter.

FIG. 3 shows a male wearing an adhesive bidirectional pathogen barrier surgical face mask. This face mask filters both inhaled and exhaled air. 30 shows the optional ear straps. The straps are not required because the solid-phase adhesive holds the mask on, but they may exist if the bidirectional pathogen barrier surgical mask is made by modifying an existing surgical mask. 32 shows the solid-phase adhesive with up to 80% added hydrocolloids to absorb moisture such as perspiration, forming a border of the adhesive bidirectional pathogen barrier surgical face mask. 34 shows the bidirectional pathogen barrier surgical face mask. 36 is an optional oxygen fitting, 38 is the optional oximeter.

FIG. 4 shows a male wearing an adhesive bidirectional pathogen barrier N95 face mask. 40 is an optional oxygen fitting. 42 is the optional oximeter. 44 is the N95 face mask. 46 is a layer of solid-phase adhesive with up to 80% added hydrocolloids to absorb moisture such as perspiration.

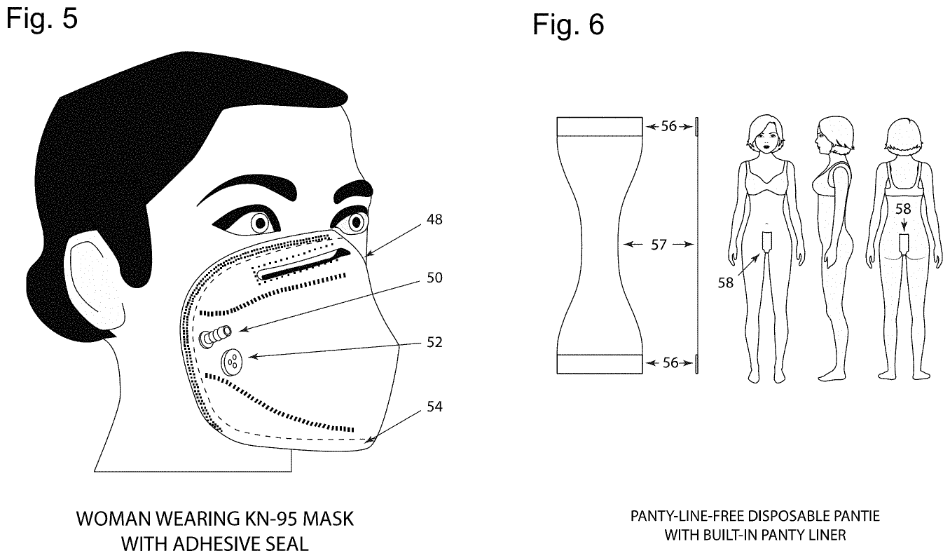

FIG. 5 shows a female wearing an adhesive bidirectional pathogen barrier KN95 face mask. 48 is the KN95 face mask. 50 is an optional oxygen fitting. 52 is an optional oximeter. 54 is a layer of the solid-phase adhesive with up to 80% added hydrocolloids to absorb moisture such as perspiration.

FIG. 6 is panty-line free panties. 56 is a layer of the solid-phase adhesive with up to 80% added hydrocolloids to absorb moisture such as perspiration. 57 is a nonwoven or woven fabric sideless pantie. 58 is a female wearing the panty-line free panties.

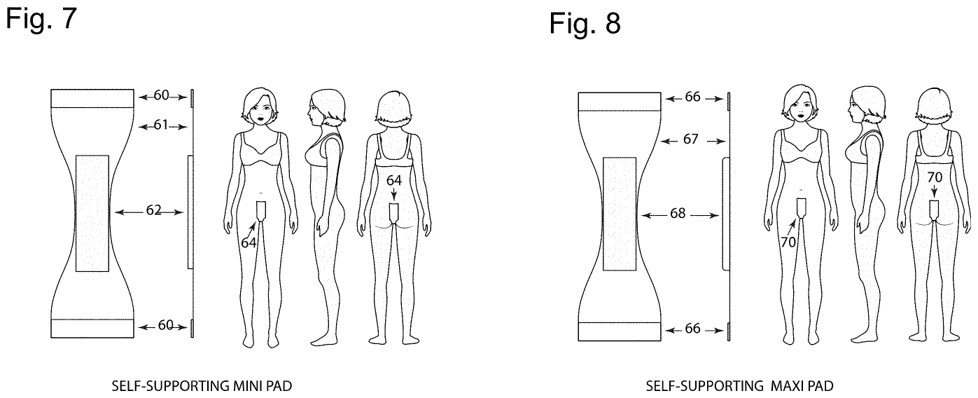

FIG. 7 is panties with built-in mini pad. 60 is a layer of solid-phase adhesive with up to 80% added hydrocolloids to absorb moisture such as perspiration. 61 is a nonwoven or woven fabric sideless pantie. 62 is a panty liner. 64 shows a female wearing the panties with built-in mini pad. In certain embodiments, the panties are disposable.

FIG. 8 is panties with built-in maxi pad. 66 is a layer of solid-phase adhesive with up to 80% added hydrocolloids to absorb moisture such as perspiration. 67 is a nonwoven or woven fabric sideless pantie. 68 is a built-in sanitary napkin. 70 is a woman wearing the female wearing the panties with built-in maxi pad. In certain embodiments, the panties are disposable.

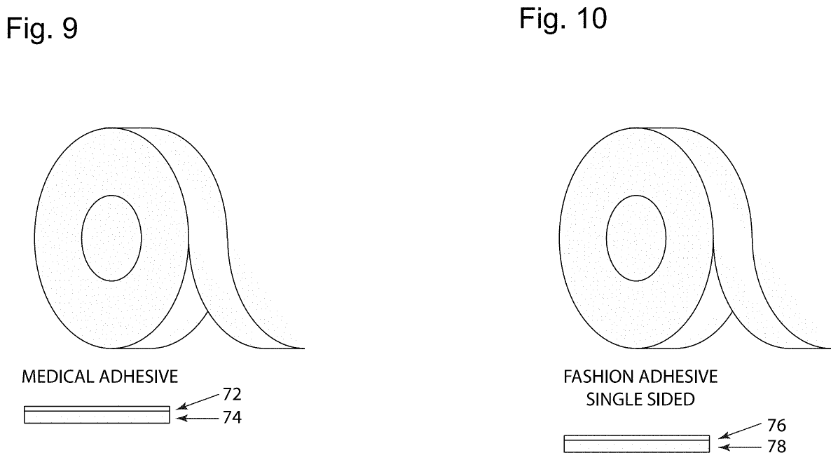

FIG. 9 shows a medical adhesive tape. 72 is a substrate. 74 is a layer of the solid-phase adhesive with to 80% added hydrocolloids to absorb moisture such as perspiration.

FIG. 10 shows a fashion adhesive tape. 76 is a substrate. 78 is a layer of the solid-phase adhesive with up to 80% added hydrocolloids to absorb moisture such as perspiration.

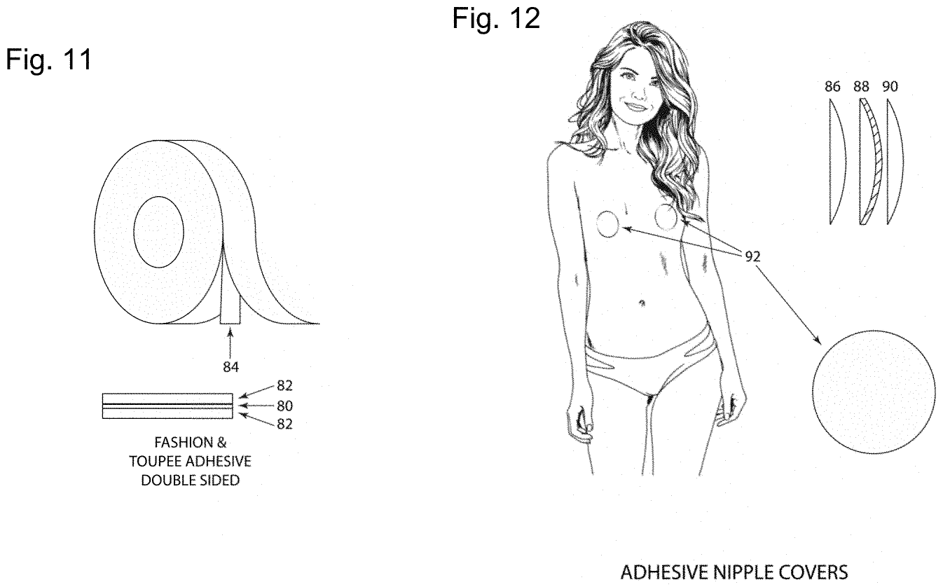

FIG. 11 shows a fashion and toupee double sided tape. 80 is a substrate. 82 is a layer of the solid-phase adhesive with up to 80% added hydrocolloids to absorb moisture such as perspiration. 84 is an optional release liner.

FIG. 12 is adhesive nipple covers. 86 is a domed release liner. 88 is a domed layer of the solid-phase adhesive with up to 80% added hydrocolloids to absorb moisture such as perspiration. 90 is a domed substrate. 92 is the nipple cover.

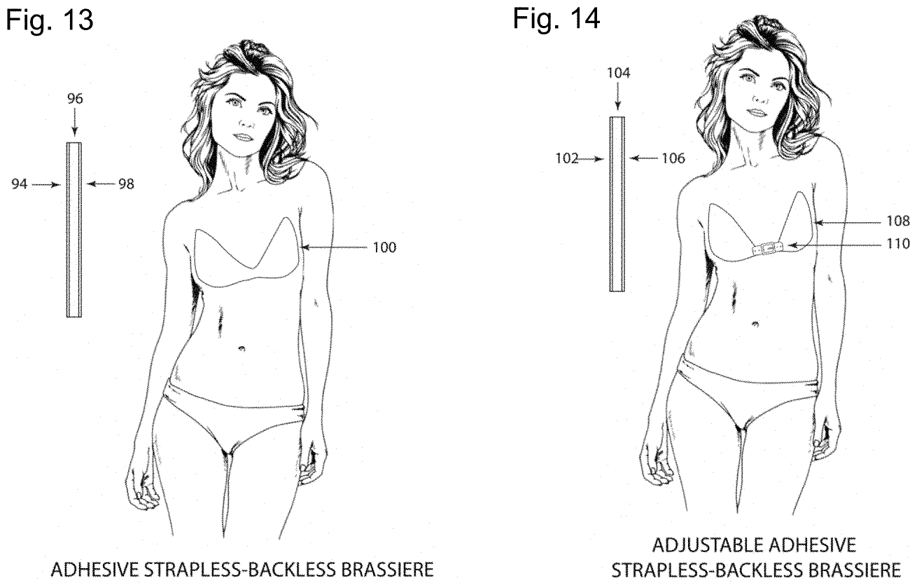

FIG. 13 is an adhesive strapless, backless brassiere. 94 is a nonwoven, woven fabric or plastic substrate. 96 is a layer of the solid-phase adhesive with up to 80% added hydrocolloids to absorb moisture such as perspiration. 98 is a release liner. 100 is the adhesive strapless, backless brassiere.

FIG. 14 is an adjustable adhesive strapless, backless brassiere. 102 is a nonwoven, woven fabric or plastic substrate. 104 is a layer of the solid-phase adhesive with up to 80% added hydrocolloids to absorb moisture such as perspiration. 106 is a release liner. 108 is the strapless, backless brassiere. 110 is an adjustable buckle.

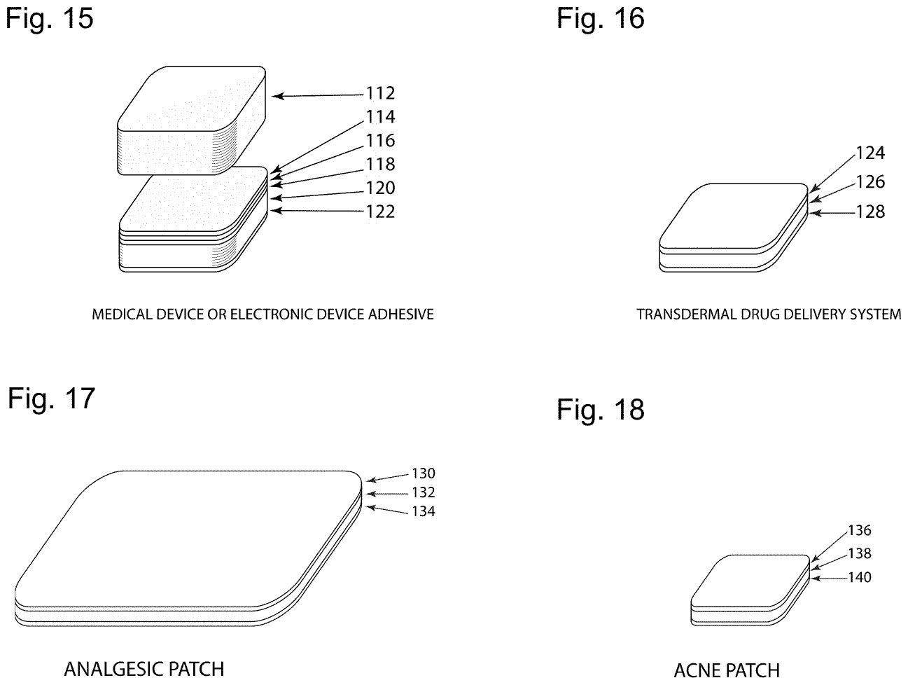

FIG. 15 is a medical device and/or electronic device adhesive. 112 is the medical device and/or electronic device, 114 is a release liner, 116 is a pressure-sensitive adhesive, 118 is a substrate. 120 is a layer of the solid-phase adhesive with up to 80% added hydrocolloids to absorb moisture such as perspiration. 122 is a release liner.

FIG. 16 is a transdermal drug delivery system. 124 is a cover film. 126 is a layer of the solid-phase adhesive with up to 80% added hydrocolloids to absorb moisture such as perspiration. 128 is a release liner.

FIG. 17 is an analgesic patch. 130 is a cover film. 132 is a layer of the solid-phase adhesive with up to 80% added hydrocolloids to absorb moisture such as perspiration. 134 is a release liner.

FIG. 18 is an acne patch. 136 is a cover film. 138 is a layer of the solid-phase adhesive with up to 80% added hydrocolloids to absorb moisture such as perspiration. 140 is a release liner.

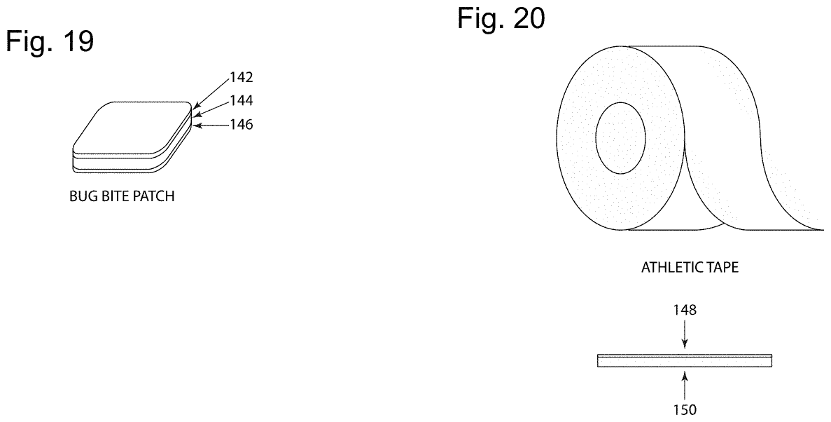

FIG. 19 is a bug bite patch. 142 is a cover film. 144 is a layer of the solid-phase adhesive with up to 80% added hydrocolloids to absorb moisture such as perspiration. 146 is a release liner.

FIG. 20 is athletic tape. 148 is a cover film. 150 is a layer of the solid-phase adhesive.

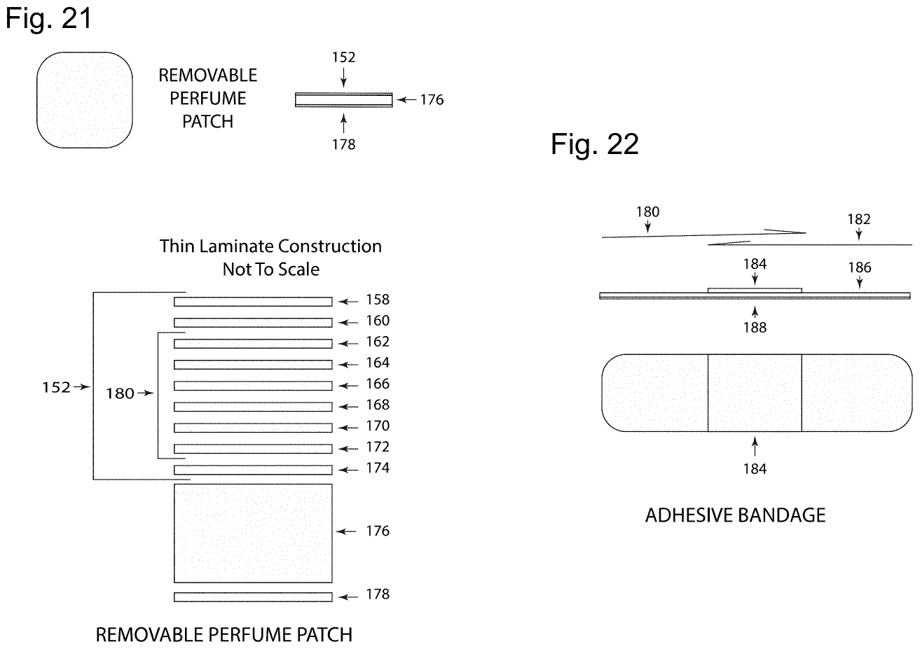

FIG. 21 is a removable perfume patch. 152 is a nine-layer dual nonwoven fabric faced laminate. 158 and 174 are nonwoven fabric layers. 160, 164, 168, and 172 are laminating adhesive layers. 162 and 172 are polyester layers. 166 is an aluminum foil layer. 180 is the group of layers used in conventional pouch packaging for food and medical products. 176 is a layer of the solid-phase adhesive with up to 80% added hydrocolloids to absorb moisture such as perspiration. 178 is a release liner.

FIG. 22 is an adhesive bandage. 180 and 182 are release liners. 184 is an optional absorbent bandage pad. 186 is a layer of the solid-phase adhesive with up to 80% added hydrocolloids to absorb moisture such as perspiration. 188 is cloth or plastic.

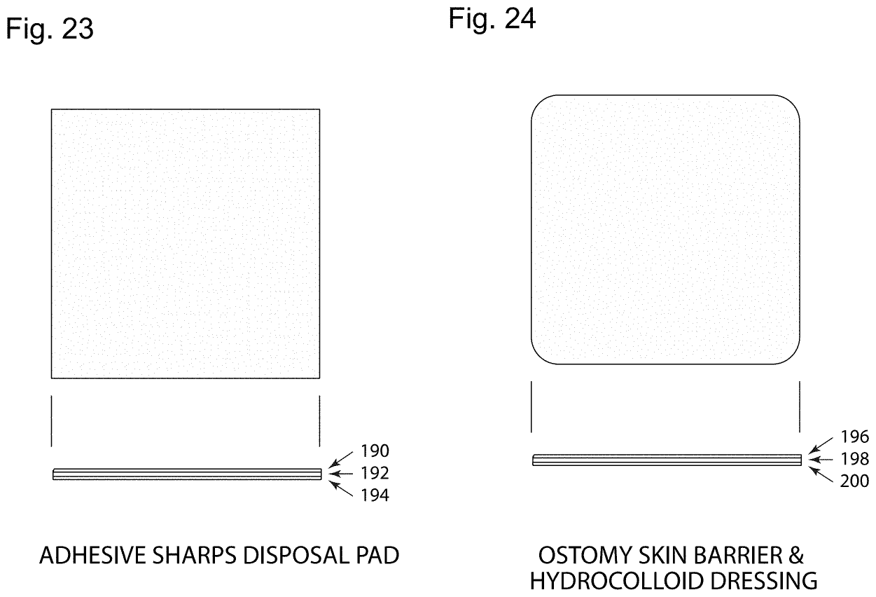

FIG. 23 is an adhesive sharps disposal pad. 190 is release liner. 192 is a layer of the solid-phase adhesive. 194 is a rear substrate.

FIG. 24 is an ostomy skin barrier and hydrocolloid dressing. 196 is a substrate. 198 is a layer of the solid-phase adhesive compounded with a hydrocolloid such as sodium carboxymethyl cellulose powder or granules. 200 is a release liner.

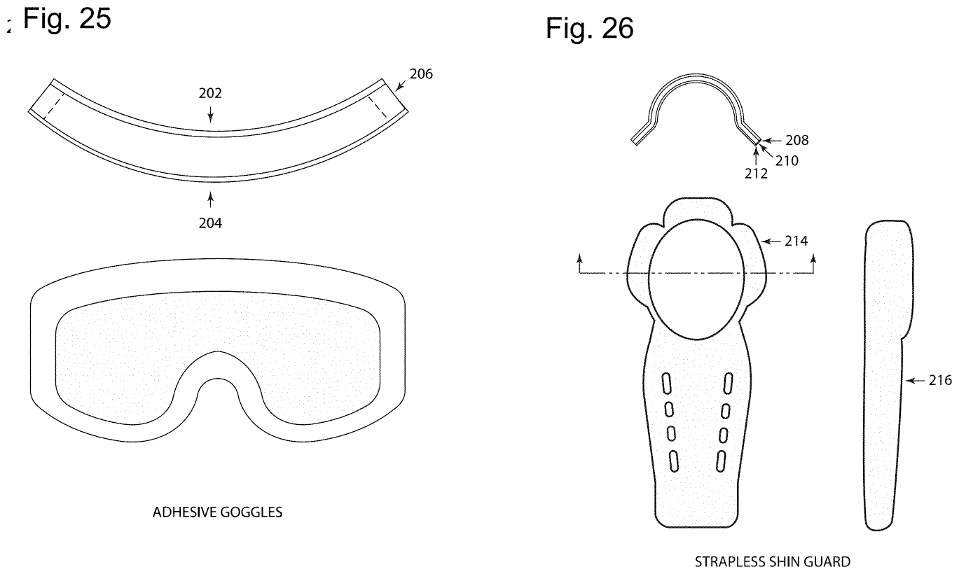

FIG. 25 is adhesive googles. 202 is a layer of the solid-phase adhesive with up to 80% added hydrocolloids to absorb moisture such as perspiration. 206 is a molded facemask frame. 204 is a transparent plastic lens.

FIG. 26 is an adhesive strapless shin guard. 208 is a hard, plastic shell. 210 is a layer of the solid-phase adhesive with up to 80% added hydrocolloids to absorb moisture such as perspiration. 212 is a reusable release liner

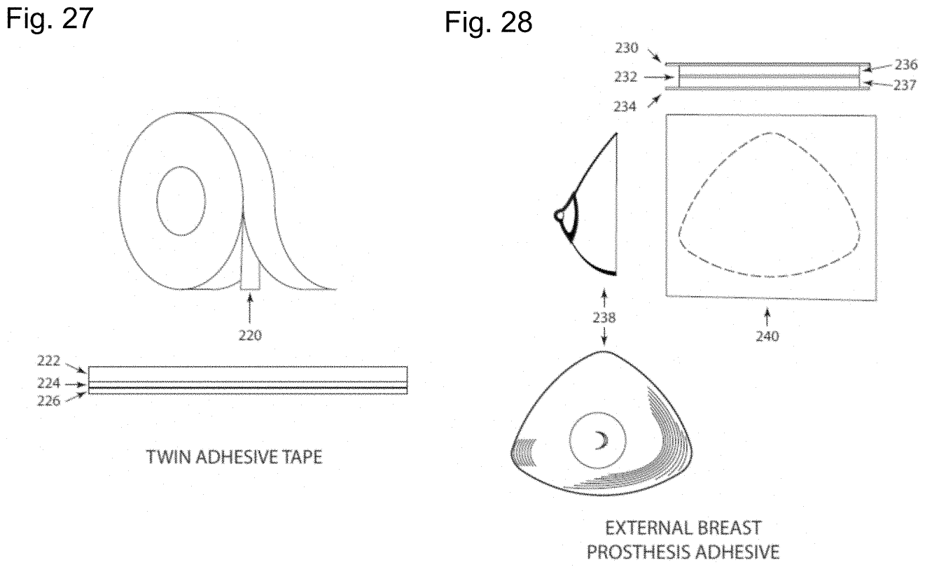

FIG. 27 is a rug adhesive. 220 is a double-sided release liner. 222 is a layer of the solid-phase adhesive. 224 is a plastic or nonwoven substrate. 226 is a layer of pressure-sensitive adhesive for securing the rub adhesive to the rug. 228 is the rug.

FIG. 28 is an adhesive external breast prosthesis. 230 is a release liner. 236 is a layer of the solid-phase adhesive. 232 is a plastic or nonwoven substrate cutout as shown in 240. 237 is a layer of pressure-sensitive adhesive, or the solid-phase adhesive with up to 80% added hydrocolloids to absorb moisture such as perspiration. 234 is a release liner. 238 is the external breast prosthesis.

FIG. 29 is an adhesive strapless elbow bad. 242 is a front view of the elbow pad. 248 is a back view of the elbow pad. 244 is a hard, outer layer of plastic. 246 is a layer of the solid-phase adhesive with up to 80% added hydrocolloids to absorb moisture such as perspiration. 250 is a cross-section view of the elbow pad.

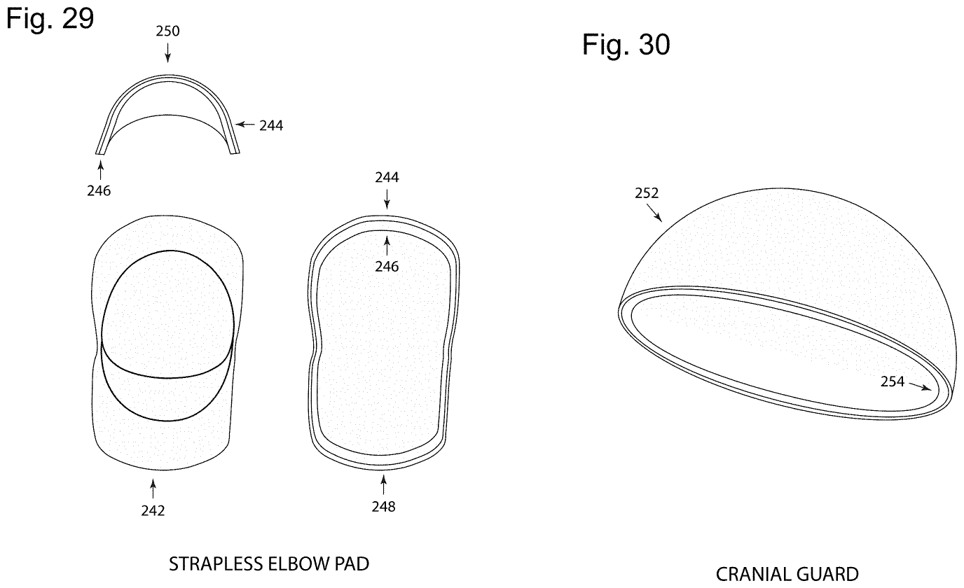

FIG. 30 is an adhesive cranial guard. 252 is a head-shaped, hard outer layer. 254 is a layer of the solid-phase adhesive with up to 80% added hydrocolloids to absorb moisture such as perspiration. The hard, outer layer 254 will have to be sized to human heads. It may have to be made from polycaprolactone, a low-melt-point plastic that may be soaked in water and crosslinked with high energy radiation, such as from an electron beam or Cobalt 60 source, to maintains its film form once heated for shaping. The electron beam will break the water into free radicals, which will crosslink the low-melt-point plastic.

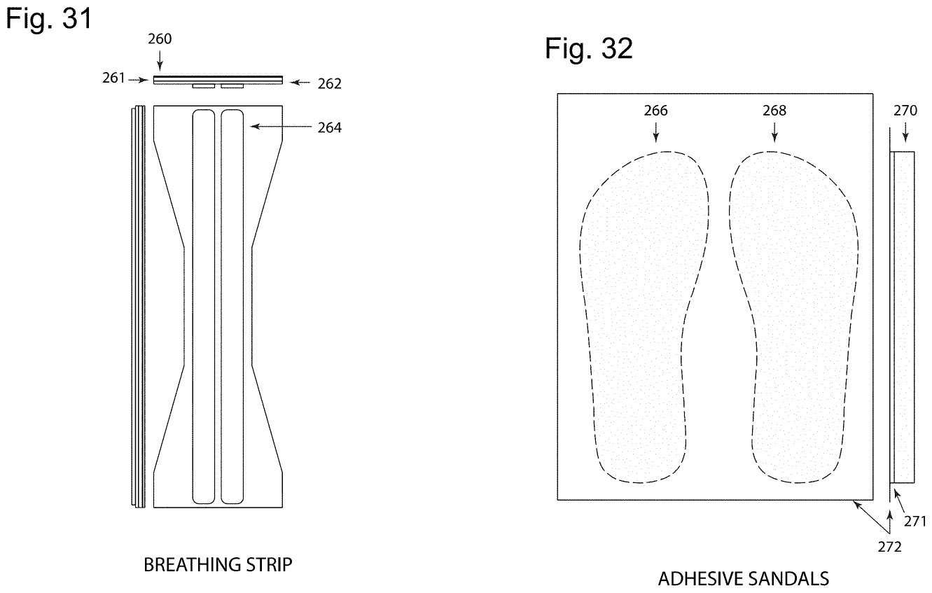

FIG. 31 is an adhesive breathing strip. 260 is a release liner. 261 is a layer of the solid-phase adhesive with up to 80% added hydrocolloids to absorb moisture such as perspiration. 262 is thin low-modulus plastic. 264 is a thicker layer of high-modulus plastic that acts as a spring to pull the nasal passages open when placed over the nose.

FIG. 32 is an adhesive sandal. 266 is the left sandal. 268 is the right sandal. 270 is a polyurethane foam sheet cut to a sandal shape. 271 is a layer of the solid-phase adhesive. 272 is a release liner.

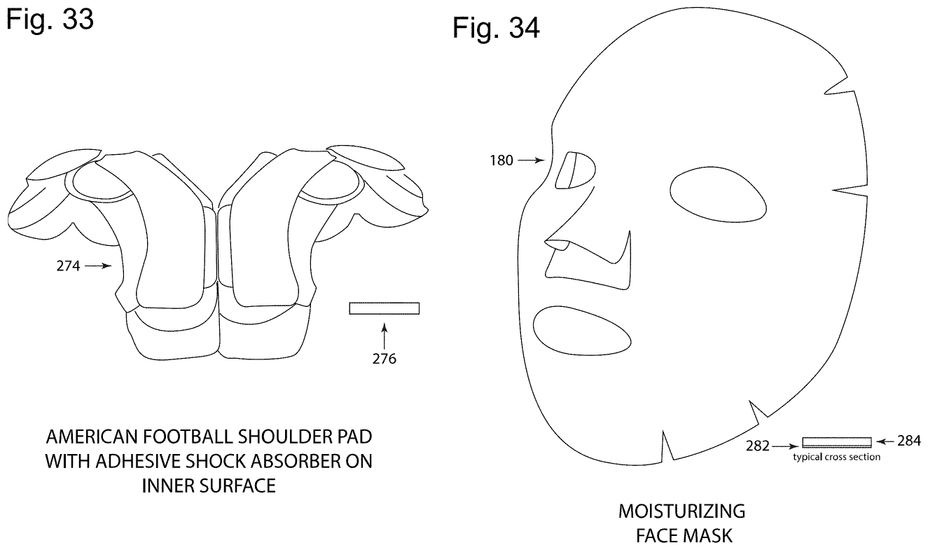

FIG. 33 is an American football shoulder pad with adhesive shock absorber on inner surface. 274 is the American football shoulder pad with an adhesive shock absorber on the inner surface. 276 is the layer of the solid-phase adhesive with up to 80% added hydrocolloids to absorb moisture such as perspiration, serves as a shock absorber on the inner surface.

FIG. 34 is a moisturizing face mask. 180 is a cut and formed facemask, preferably made from nonwoven fabric. 282 is the formed facemask. 284 is a layer of the solid-phase adhesive solid-phase. The hydrophobic liquid components of the adhesive serve as a moisturizer. Preferably, this adhesive would contain a light moisturizer, such as Puresyn 2, at a high level, such as 40%.

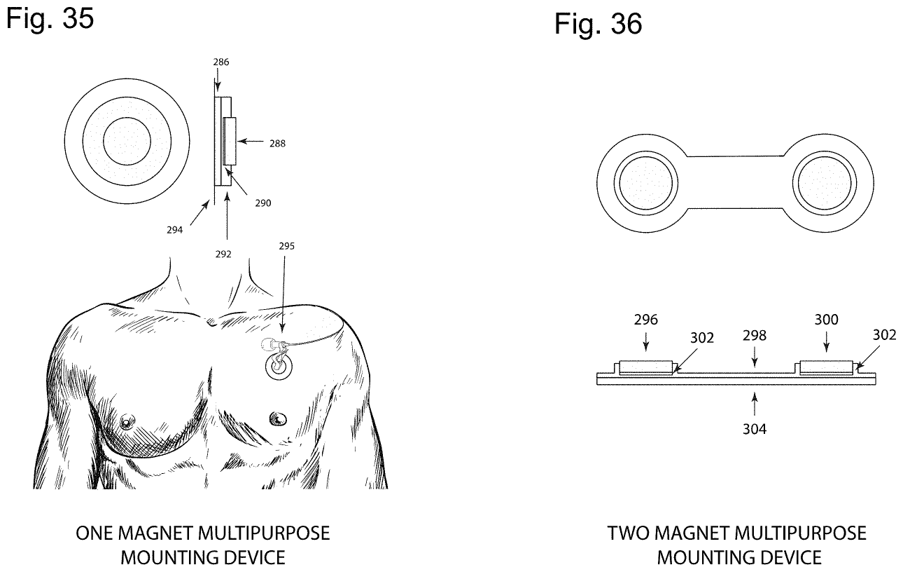

FIG. 35 is a one magnet multipurpose mounting device. 288 is a magnet. 290 is a pressure-sensitive adhesive. 292 is a molded magnet support. 286 is a layer of the solid-phase adhesive with up to 80% added hydrocolloids to absorb moisture such as perspiration. 294 is a release liner. 295 is a microphone held on by the magnet.

FIG. 36 is a two magnet multipurpose mounting device. 296 is a magnet. 298 is a molded magnet support. 300 is a magnet. 302 is a pressure-sensitive adhesive. 304 is a layer of the solid-phase adhesive with up to 80% added hydrocolloids to absorb moisture such as perspiration.

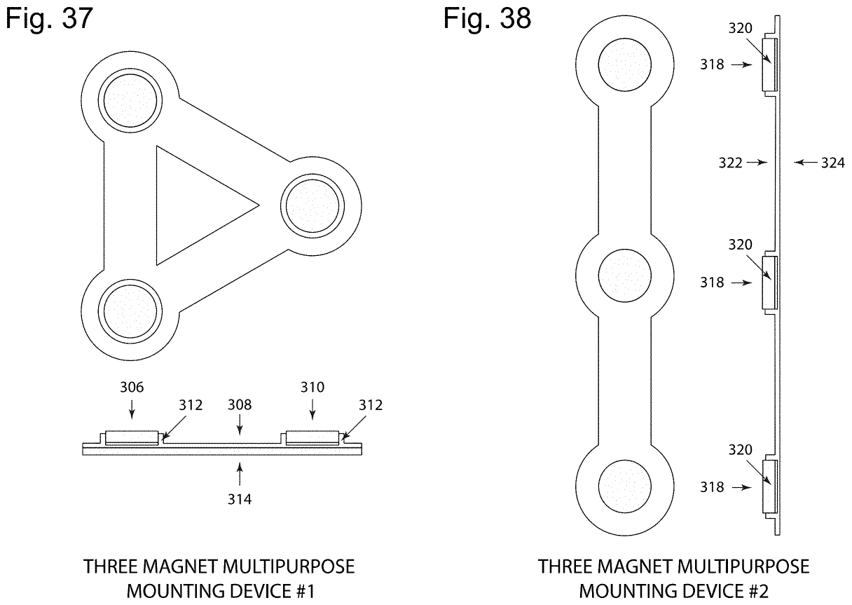

FIG. 37 is a three magnet multipurpose mounting device. 306 and 310 are magnets. There is a third magnet hidden behind 306. 308 is a molded magnet support. 312 is a pressure-sensitive adhesive. 314 is a layer of solid-phase adhesive with up to 80% added hydrocolloids to absorb moisture such as perspiration.

FIG. 38 is another embodiment of the three magnet multipurpose mounting device. 318 are magnets. 322 is a molded magnet support. 320 is a pressure-sensitive adhesive. 324 is a layer of the solid-phase adhesive with up to 80% added hydrocolloids to absorb moisture such as perspiration.

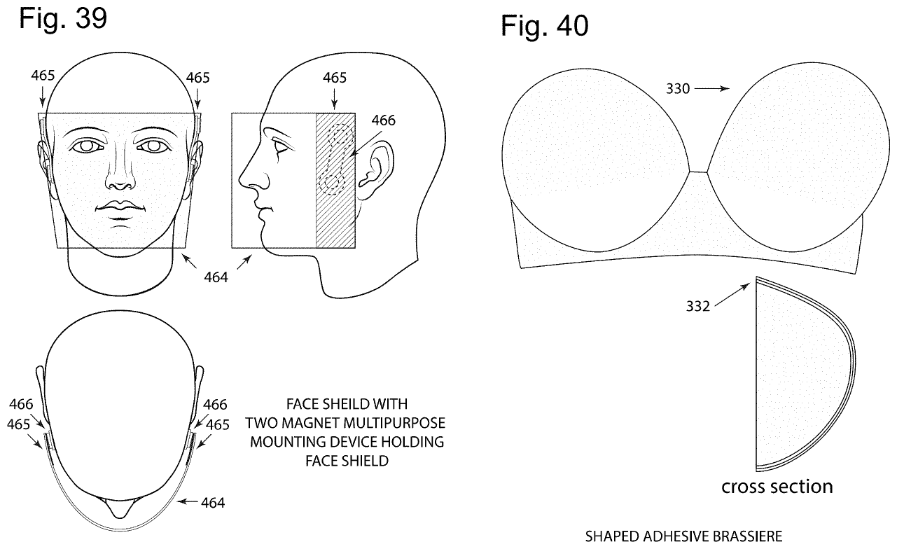

FIG. 39 is a two magnet multipurpose mounting device holding face shield. 326 is a face shield. 328 is the two magnet multipurpose mounting device from FIG. 36 with up to 80% added hydrocolloids to absorb moisture such as perspiration.

FIG. 40 is a shaped adhesive brassiere. 330 is a shaped brassiere. 332 is a layer of solid-phase adhesive with up to 80% added hydrocolloids to absorb moisture such as perspiration.

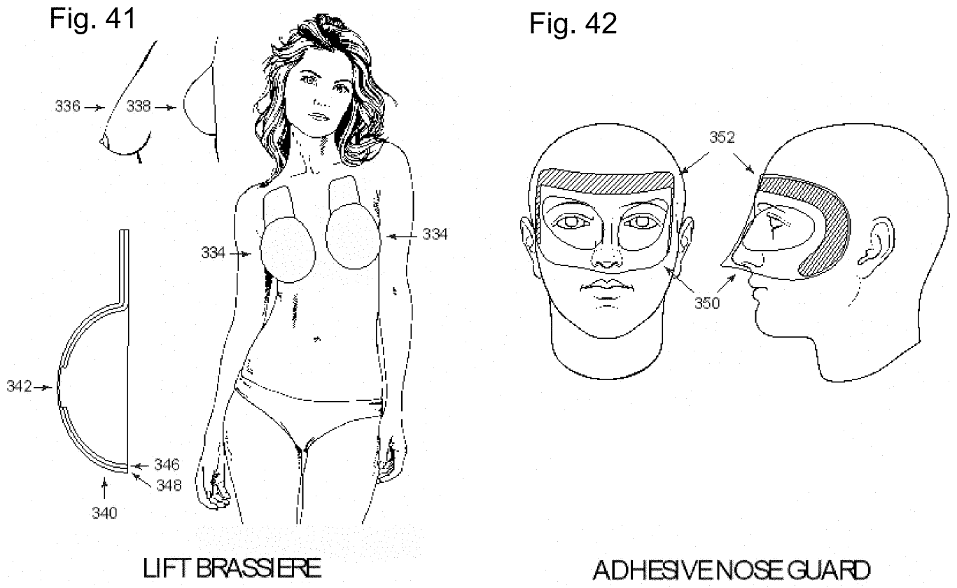

FIG. 41 is an adhesive lift brassiere. 334 is the lift brassiere. 336 is a human breast with ptosis. 338 is the same breast shown with the lift brassiere. 348 is the plastic shell of the lift brassiere (shown cross-section). 342 is the nipple cut out of the lift brassiere plastic shell (shown in cross-section). 346 is a layer of the solid-phase adhesive with up to 80% added hydrocolloids to absorb moisture such as perspiration (shown in cross-section).

FIG. 42 is an adhesive nose guard. 350 is a clear plastic nose guard. 352 is a layer of the solid-phase adhesive with up to 80% added hydrocolloids to absorb moisture such as perspiration.

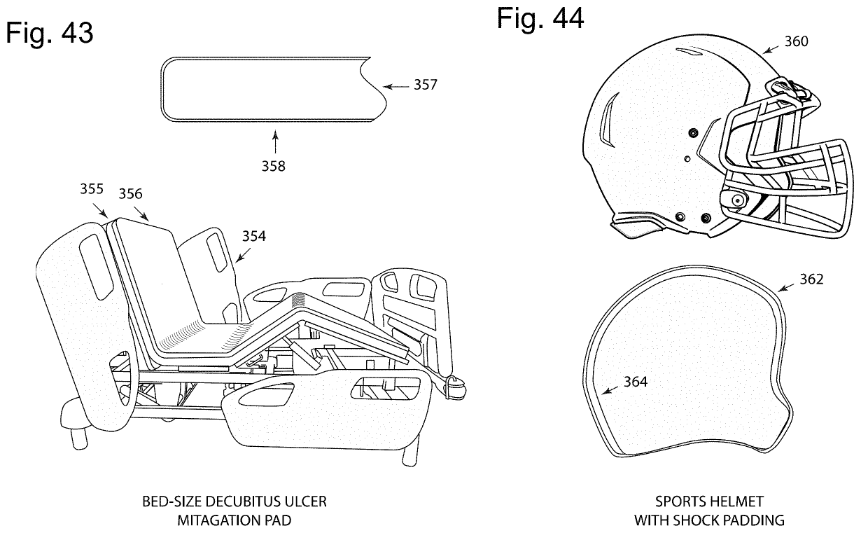

FIG. 43 is a decubitus ulcer mitigation pad. 354 is a hospital bed. 355 is a mattress. 356 is the decubitus ulcer mitigation pad. 357 is a close-up cross-section of the end of the decubitus ulcer mitigation pad, filled with the solid-phase adhesive with up to 80% added hydrocolloids to absorb moisture such as perspiration. 358 is a thin, flexible shell.

FIG. 44 is sports helmet with shock padding (sports helmet shown is an American Football helmet, but the invention is not limited to the American football sports helmet but instead applies to all sports helmets) 360 is the sports helmet. 362 is the outer shell of the sports helmet shown in the cross-section view. 364 is the shock padding made from the solid-phase adhesive with up to 80% added hydrocolloids to absorb moisture such as perspiration.

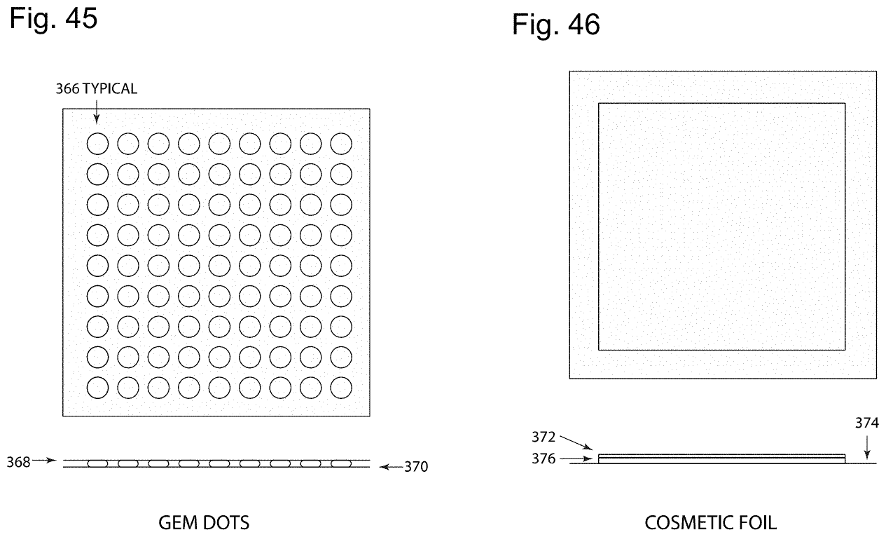

FIG. 45 is gem dots. 366 is the gem dot made from solid-phase adhesive with up to 80% added hydrocolloids to absorb moisture such as perspiration. 368 is a release liner. 370 is a release liner. One can employ alternative packaging methods.

FIG. 46 is a cosmetic foil. 372 is the cosmetic foil. 374 is a release liner. 376 is solid-phase adhesive with up to 80% added hydrocolloids to absorb moisture such as perspiration.

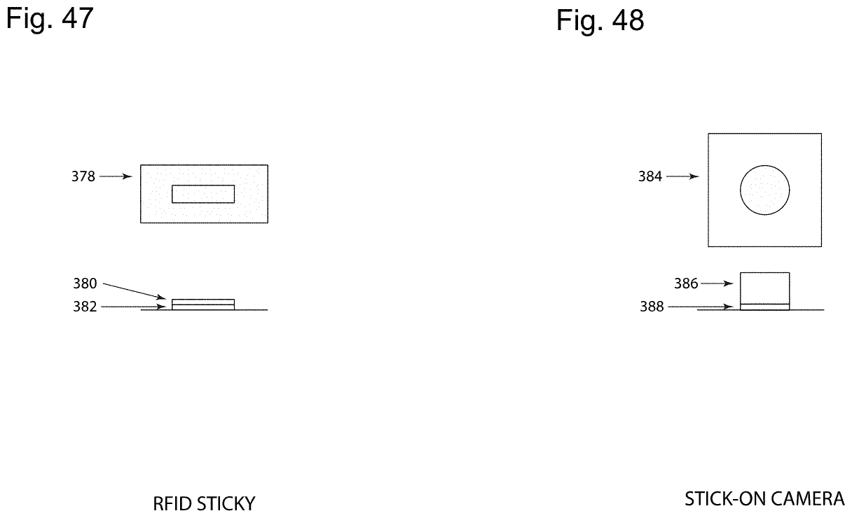

FIG. 47 is an RFID sticky. 378 is a release liner. 380 is an RFID device. 382 is the solid-phase adhesive with up to 80% added hydrocolloids to absorb moisture such as perspiration.

FIG. 48 is a stick-on camera. 384 is a release liner. 386 is a camera. 388 is the solid-phase adhesive with up to 80% added hydrocolloids to absorb moisture such as perspiration.

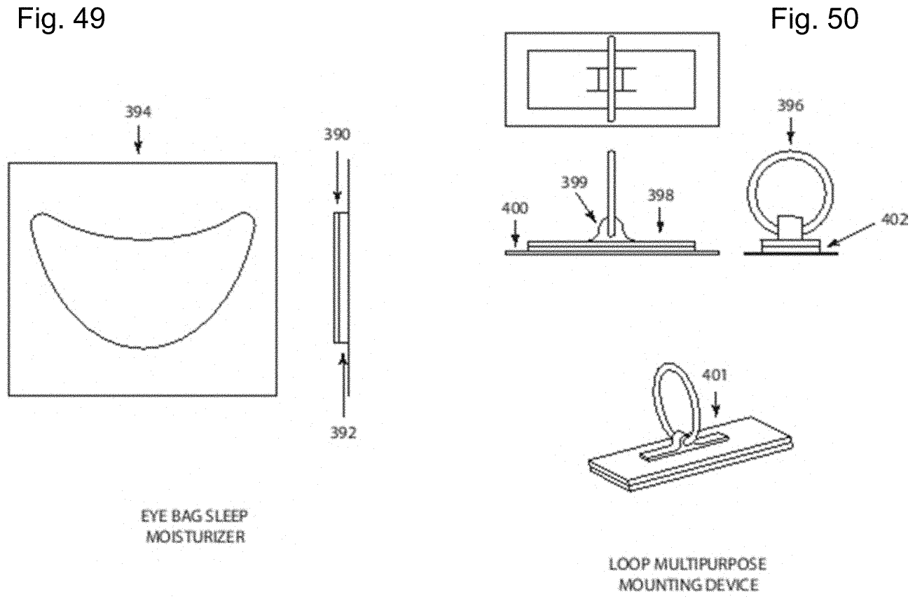

FIG. 49 is eye bag reducing emollient. 394 is a release liner. 392 is a substrate such as plastic or nonwoven fabric. 388 is the solid-phase adhesive formulated with a significant emollient level, such as ExxonMobil's PureSyn 2, with or without up to 80% added hydrocolloids to absorb moisture such as perspiration.

FIG. 50 is a loop multipurpose mounting device. 396 is a metal or plastic loop. 398 is a molded elastomeric shape comprising a sheet of elastomer with 399 a loop attachment point. 400 is a release liner. 401 is an isometric drawing. 402 is the solid-phase adhesive with up to 80% added hydrocolloids to absorb moisture such as perspiration.

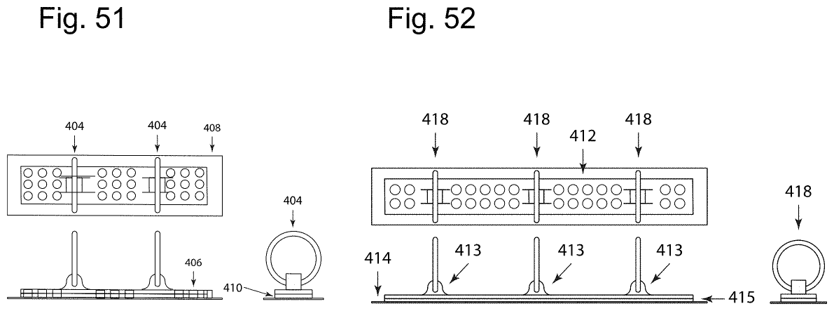

FIG. 51 is a two loop multipurpose mounting device. 404 is a metal or plastic loop. 416 is a molded elastomeric shape comprising an elastomer sheet with two 407 loop attachment points. 408 is a release liner. 410 is the solid-phase adhesive with up to 80% added hydrocolloids to absorb moisture such as perspiration.

FIG. 52 is a three loop multipurpose mounting device. 412 is a molded elastomeric shape comprising a sheet of elastomer with three 413 loop attachment points. 414 is a release liner. 415 is the solid-phase adhesive. 418 are metal or plastic loops. 415 is the solid-phase adhesive with up to 80% added hydrocolloids to absorb moisture such as perspiration.

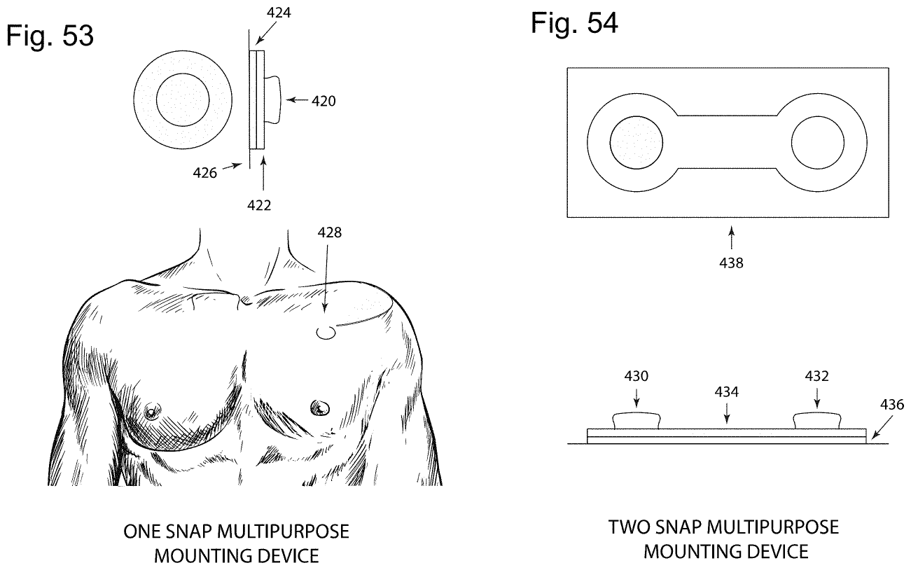

FIG. 53 is a snap multipurpose mounting device. 420 is a metal or plastic, male or female snap. 422 is a molded elastomeric shape securing the snap. 424 is the solid-phase adhesive with up to 80% added hydrocolloids to absorb moisture such as perspiration. 426 is a release liner.

FIG. 54 is a two snap multipurpose mounting device. 430 and 432 are metal or plastic, male or female snaps. 434 are molded elastomeric shape securing the snaps. 436 is the solid-phase adhesive with up to 80% added hydrocolloids to absorb moisture such as perspiration. 438 is a release liner.

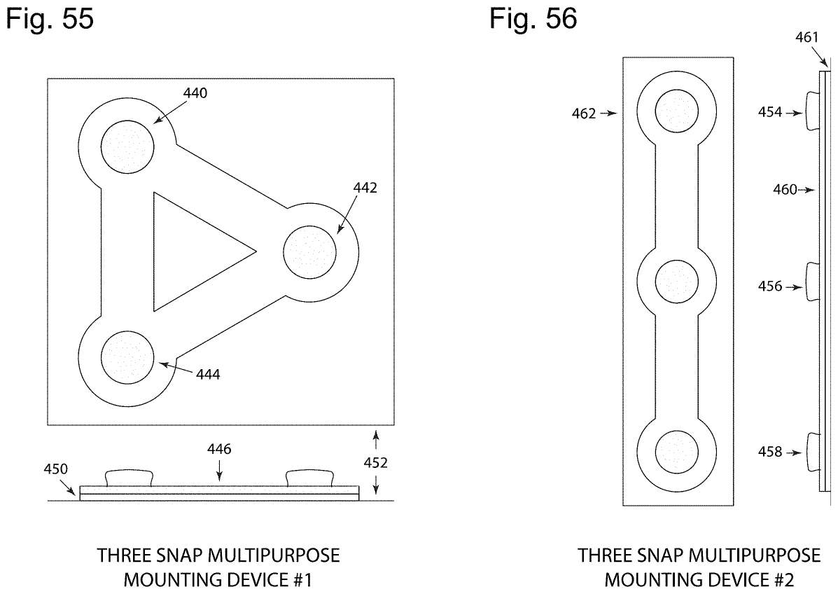

FIG. 55 is a three snap multipurpose mounting device. 440, 442, and 444 are metal or plastic, male or female snaps. 446 is a molded elastomeric shape securing the snaps. 450 is the solid-phase adhesive with up to 80% added hydrocolloids to absorb moisture such as perspiration. 452 is a release liner.

FIG. 56 is another embodiment of the three snap multipurpose mounting device. 454, 456, and 458 are metal or plastic, male or female snaps. 460 is a molded elastomeric shape securing the snaps. 461 is the solid-phase adhesive with up to 80% added hydrocolloids to absorb moisture such as perspiration. 462 is a release liner.

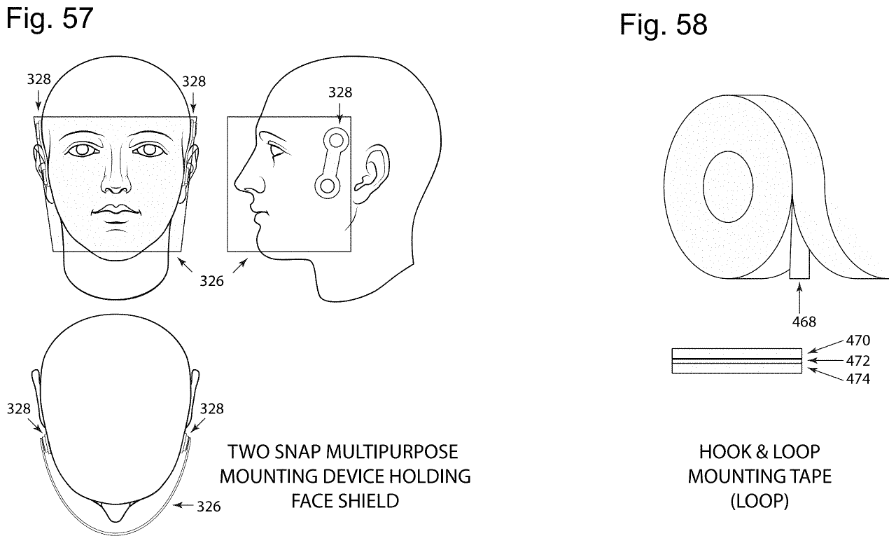

FIG. 57 is a face shield and an adhesive two snap multipurpose mounting device holding the face shield. 464 is a clear plastic face shield. 465 are magnetic metal strips attached to the face shield. 466 are the two snap multipurpose mounting device.

FIG. 58 is a loop portion of a hook and loop mounting tape. 468 is the release liner. 470 is the loop portion of the hook and loop mounting ribbon. 472 is an optional barrier layer. 474 is the solid-phase adhesive with up to 80% added hydrocolloids to absorb moisture such as perspiration. 462 is a release liner.

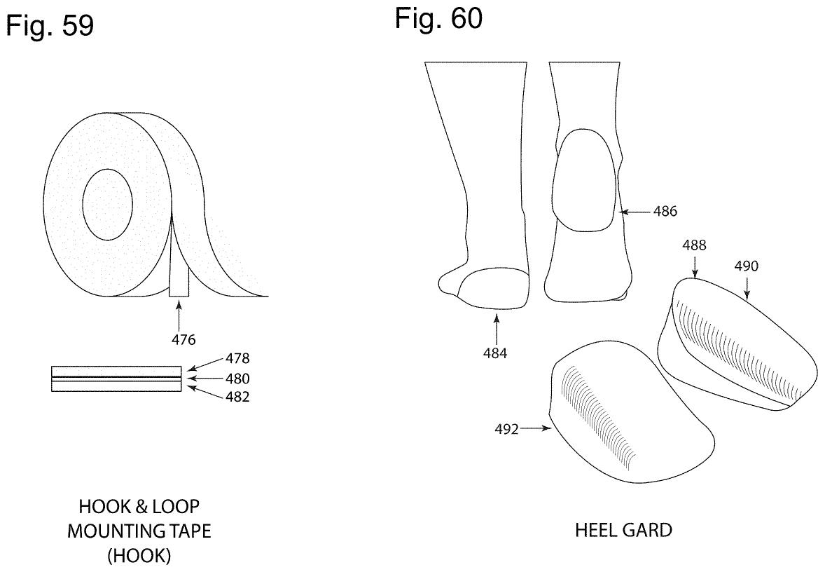

FIG. 59 is a hook portion of the hook and loop mounting tape. 476 is the release liner. 478 is hook portion of the hook and loop mounting ribbon. 480 is an optional barrier layer. 482 is the solid-phase adhesive with up to 80% added hydrocolloids to absorb moisture such as perspiration.

FIG. 60 is an adhesive heel guard. 484 is a person wearing a heel guard with a heel down. 486 is a person wearing a heel guard with a heel cup. 488 is outer plastic or formed a nonwoven shell of heel guard. 490 is the solid-phase adhesive with up to 80% added hydrocolloids to absorb moisture such as perspiration. 492 is the heel guard inverted.

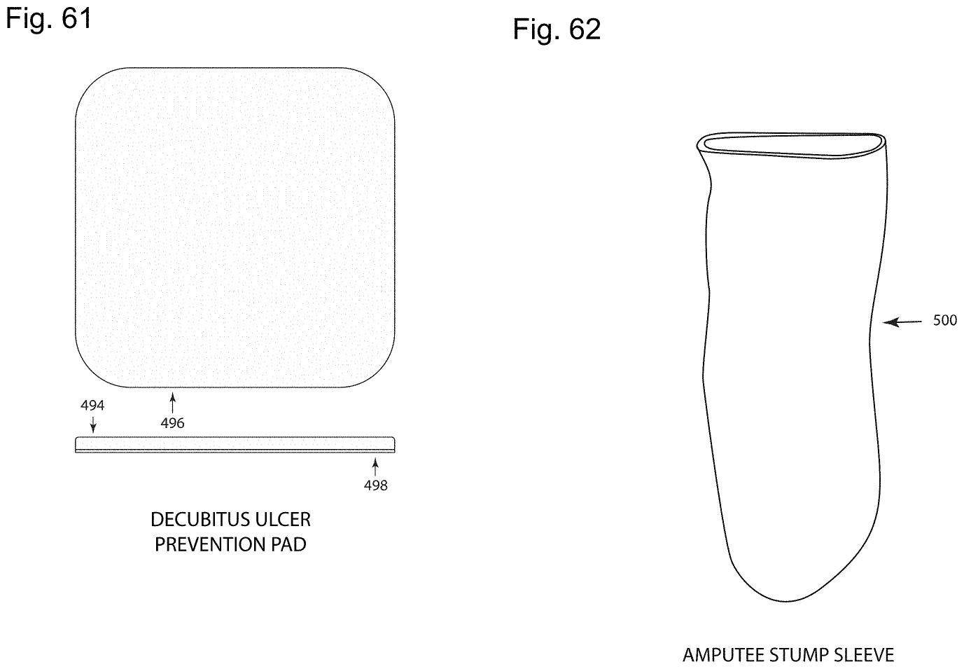

FIG. 61 is an adhesive decubitus ulcer avoidance pad. 496 is a decubitus ulcer avoidance pad. 494 is the solid-phase adhesive with up to 80% added hydrocolloids to absorb moisture such as perspiration. 498 is a substrate such as a plastic sheet.

FIG. 62 is an adhesive amputee stump sleeve. 500 is the amputee stump sleeve, made from a specially formulated version of the solid-phase adhesive with up to 80% added hydrocolloids to absorb moisture such as perspiration.

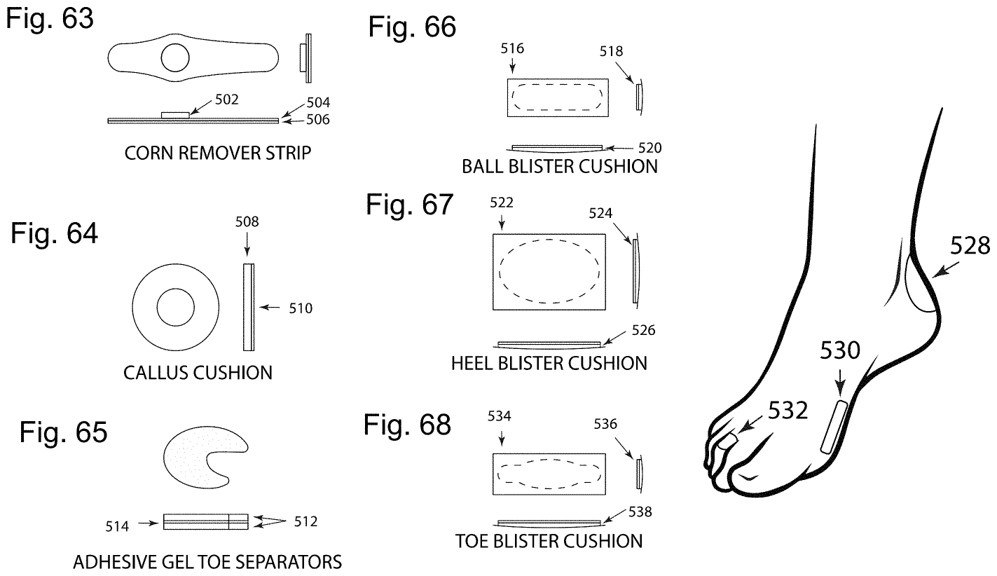

FIG. 63 is an adhesive corn remover strip. 502 is a salicylic acid patch (typically 40%). 504 is the solid-phase adhesive with up to 80% added hydrocolloids to absorb moisture such as perspiration. 5506 is a substrate, such as a plastic sheet.

FIG. 64 is an adhesive callus cushion. 508 is a punched shape, about 0.125 inches thick, about 1.375 inches in diameter, with a hole about 0.625 inches in diameter made from the solid-phase adhesive with up to 80% added hydrocolloids to absorb moisture such as perspiration. 510 is a substrate such as a nonwoven fabric or plastic sheet.

FIG. 65 is an adhesive gel toe separator. 512 is a punched shape, about 0.125 inches thick, made from the solid-phase adhesive with up to 80% added hydrocolloids to absorb moisture such as perspiration. 512 is a substrate such as a nonwoven fabric or plastic sheet.

FIG. 66 is an adhesive ball blister cushion. 516 is a release liner. 518 is a substrate such as a nonwoven fabric or plastic sheet. 520 is a domed shape molded out of the solid-phase adhesive with up to 80% added hydrocolloids to absorb moisture such as perspiration.

FIG. 67 is an adhesive heel blister cushion. 522 is a release liner. 524 is a substrate, such as a nonwoven fabric or plastic sheet. 524 is a domed shape molded out of the solid-phase adhesive with up to 80% added hydrocolloids to absorb moisture such as perspiration.

FIG. 68 is an adhesive toe blister cushion. 534 is a release liner. 536 is a substrate such as a nonwoven fabric or plastic sheet. 538 is a domed shape molded out of the solid-phase adhesive with up to 80% added hydrocolloids to absorb moisture such as perspiration.

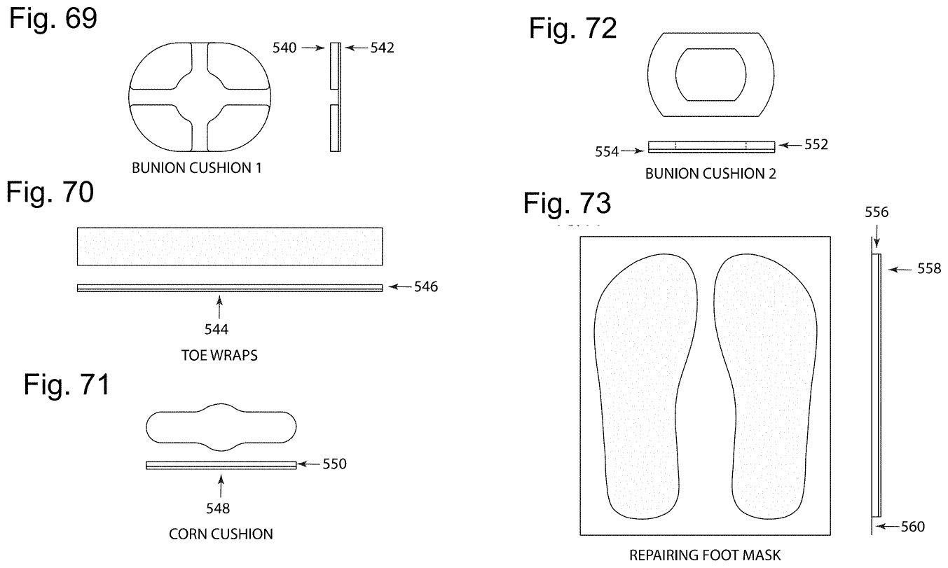

FIG. 69 is an adhesive bunion cushion. 542 is a substrate such as a nonwoven fabric or plastic sheet. 540 is a shape molded out of the solid-phase adhesive with up to 80% added hydrocolloids to absorb moisture such as perspiration.

FIG. 70 is another embodiment of the adhesive bunion cushion. 548 is a substrate such as a nonwoven fabric or plastic sheet. 550 is a shape molded out of the solid-phase adhesive with up to 80% added hydrocolloids to absorb moisture such as perspiration.

FIG. 72 is another embodiment of the adhesive bunion cushion. 554 is a substrate such as a nonwoven fabric or plastic sheet. 552 is a shape molded out of the solid-phase adhesive with up to 80% added hydrocolloids to absorb moisture such as perspiration.

FIG. 73 is an adhesive exfoliating foot peel. 556 is the solid-phase adhesive with up to 80% added hydrocolloids to absorb moisture such as perspiration. 558 is a substrate, such as a nonwoven fabric or plastic sheet. 560 is a release liner. The repairing foot mask consists of a foot-shaped cutout coated with the solid-phase adhesive and a release liner. The hydrophobic liquids serve as an emollient. Examples of hydrophobic liquids that may be used include, but are not limited to, butyloctanol, C12, C12-17, C14-22, caprylic/capric triglyceride, coco-caprylate, cocoyl adipic acid/trimethylolpropane copolymer, 1,2-cyclohexane dicarboxylic acid diisononyl ester, butyl stearate, dicaprylyl ether, diethylhexyl sebacate, diisobutyl adipate, diisostearyl fumarate, diisostearyl malate, dimerdiol-carbonate, dodecane, hexyldecanol, hydrogenated poly(C6-14 olefin), hydrogenated polydecine, isononyl isononanoate, isopropyl shea butterate (and) dodecane (and) hexadecane, isostearyl isostearate, isostearyl lactate, lauryl lactate, lauryl lactyl lactate, neopentyl glycol diethylhexanoate, octyldodecanol, octyldodecyl lactate, octyldodecyl stearate, octyldodecyl stearoyl stearate, oleyl alcohol, oleyl erucate, oleyl lactate, PEG/PPG-8/3 diisostearate, polybutene, PPG-26/dimer dilinoleate copolymer (and) isononyl isononanoate (and) ethylhexyl isononanoate, propylene glycol dicaprylate/dicaprate, propylheptyl caprylate, triisostearyl citrate, undecane (and) tridecane, esters typically used in cosmetics, liquid hydrocarbon polymers, and hydrogenated liquid hydrocarbon polymers.

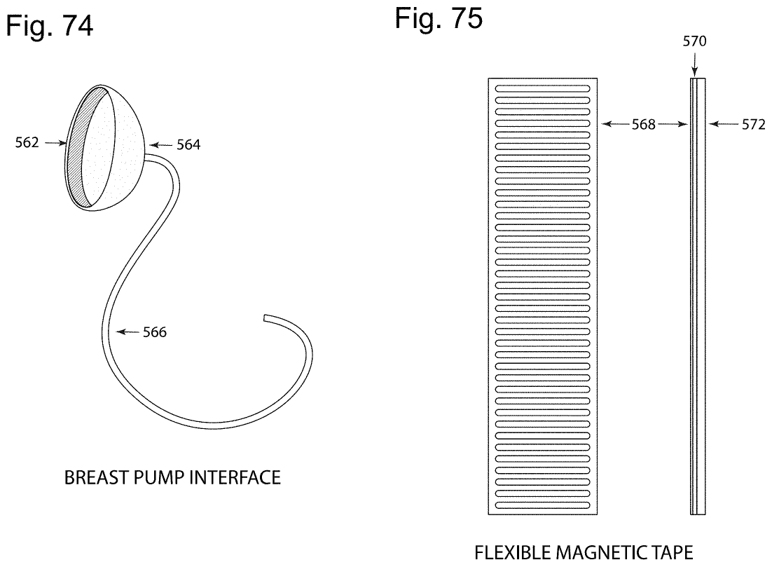

FIG. 74 is an adhesive breast pump interface. 562 is a shape molded out of the solid-phase adhesive with up to 80% added hydrocolloids to absorb moisture such as perspiration. 564 is a cup made out of nonwoven fabric or plastic sheet. 566 is a tube that will plug into the breast pump (not shown).

FIG. 75 is an adhesive flexible magnetic tape. 568 is a thin, flexible shape cut out of a magnetic metal, such as a 400 series stainless steel. 570 is a sheet of material such as nonwoven fabric or plastic. 572 is the solid-phase adhesive with up to 80% added hydrocolloids to absorb moisture such as perspiration.

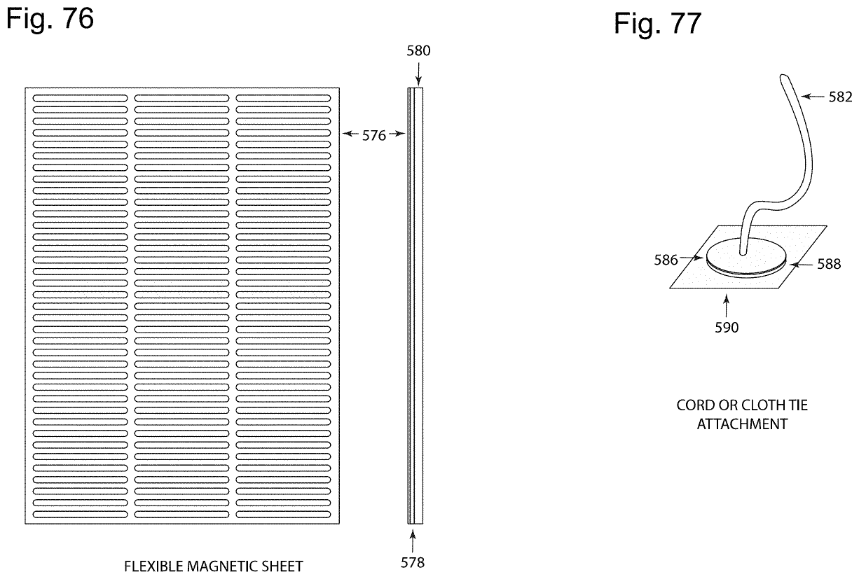

FIG. 76 is an adhesive flexible magnet sheet. 576 is a thin, flexible shape cut out of a magnetic metal, such as a 400 series stainless steel. 578 is a sheet of material such as nonwoven fabric or plastic. 580 is the solid-phase adhesive with up to 80% added hydrocolloid.

FIG. 77 is a cord or cloth tie attachment. The cord or cloth tie attachment consists of a disk or other shape of substrate 586 with a cord 582 attached at least about a quarter inch from the edge and, most preferably, in the center. The side opposite the cord or cloth tie with the solid-phase adhesive with up to 80% added hydrocolloids to absorb moisture such as perspiration 588. A release liner 590 to the solid-phase adhesive.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Fig.(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A solid-phase adhesive comprising, based on 100 percent of the solids weight of the solid-phase adhesive:
at least 20 weight percent of a low molecular weight resin produced by the polymerization and hydrogenation of styrenic monomer feedstock having a ring and ball softening point of between about 10° C. and about 45° C.;
between about 2 weight percent and about 40 weight percent of a triblock copolymer with a saturated elastomeric block intermediate opposite ends thereof and a thermoplastic block on each end; and
up to about 50 weight percent of a hydrophobic liquid.

2. The solid-phase adhesive of claim 1, wherein the low molecular weight resin has a weight average molecular weight of between about 375 and about 430.

3. The solid-phase adhesive of claim 1, wherein the low molecular weight resin comprises at least one of REGALREZ 1018 and 1033

4. The solid-phase adhesive of claim 1, wherein the low molecular weight resin comprises between about 70 weight percent and 95 weight percent of the solid-phase adhesive.

5. The solid-phase adhesive of claim 1, wherein the triblock copolymer further comprises a diblock copolymer of a hard, thermoplastic block and a saturated, soft ethylene/butylene polymeric block.

6. The solid-phase adhesive of claim 1, wherein the hydrophobic liquid comprises between about 1 weight percent and about 15 weight percent of the solid-phase adhesive.

7. The solid-phase adhesive of claim 1, wherein the solid-phase adhesive has a Young's modulus of less than about 2 psi.

8. The solid-phase adhesive of claim 1, wherein the hydrophobic liquid comprises butyl stearate, butyloctanol, C12 alcane, C12-17 alcane, C14-22 alcane, caprylic/capric triglyceride, coco-caprylate, cocoyl adipic acid/trimethylolpropane copolymer, dicaprylyl ether, diethylhexyl sebacate, diisobutyl adipate, 1,2-cyclohexane dicarboxylic acid diisononyl ester, diisostearyl fumarate, diisostearyl malate, dimerdiol-carbonate, isododecane, hexyldecanol, hydrogenated poly(C6-14 olefin), hydrogenated polydecine, isononyl isononanoate, isopropyl shea butterate (and) dodecane (and) hexadecane, isostearyl isostearate, isostearyl lactate, lauryl lactate, lauryl lactyl lactate, neopentyl glycol diethylhexanoate, octyldodecanol, octyldodecyl lactate, octyldodecyl stearateo octyldodecyl stearoyl stearate, oleyl alcohol, oleyl erucate, oleyl lactate, PEG/PPG-8/3 diisostearate, polybutene, PPG-26/dimer dilinoleate copolymer (and) isononyl isononanoate (and) ethylhexyl isononanoate, propylene glycol dicaprylate/dicaprate, propylheptyl caprylate, triisostearyl citrate, undecane (and) tridecane) and combinations thereof.

9. The solid-phase adhesive of claim 1, and further comprising a hydrocolloid at a concentration of up to about 80 weight percent.

10. The solid-phase adhesive of claim 9, wherein the hydrocolloid comprises sodium carboxymethyl cellulose, hydroxyethylcellulose, microcrystalline cellulose, xanthan gum, fructan gum, carrageenan, acacia senegal gum, tara gum, caesalpinia spinosa gum, guar gum, rhizobium gum, sclerotium gum, dehydroxanthan gum, natto gum, carboxymethylcellulose, biosaccharide gum-4, biosaccharide gum-2, hydrolyzed soy protein, biosaccharide gum-1, ceratonia siliqua (carob) gum, chondrus crispus, bentonite, agar, inulin, maltodextrin, polyglutamic acid, neutralized polyacrylic acid, neutralized methacrylic acid, polyquaternium-7 (neutralized 2-propen-1-aminium, N, N-dimethyl-N-2-propenyl-, chloride, polymer with 2-propenamide), neutralized dimethylaminoethyl methacrylate, neutralized 3-trimethylammonium propyl methacrylamide, neutralized 3-dimethylaminopropyl methacrylamide, neutralized acrylates copolymer, hydroxypropyl methylcellulose, hydroxypropyl cellulose, neutralized 2-propen-1-aminium, N,N-dimethyl-N-2-propenyl-, polymer with 2-propenoic acid, neutralized poly(diallyldimethylammonium, neutralized 2-propen-1-aminium, N,N-dimethyl-N-2-propenyl-, chloride, polymer with 2-propenamide and 2-propenoic acid, butendiol/vinyl alcohol copolymer, polyvinylpyrrolidone, polyvinyl caprolactam, carbomer, polyethylene glycol, polyethylene oxide, polyquaternium-10, guar hydroxypropyltrimonium chloride, cetyl hydroxyethylcellulose, sodium polystyrene sulfonate, schizophyllan, polyethyloxazoline, PEG-8 dimethicone (and) PEG-8 ricinoleate, calcium/sodium PVM/MA copolymer, 2-propenoic acid, 2-methyl-, polymer with butyl 2-propenoate and methyl 2-methyl-2-propenoate, galactoarabinan, carbomer 980 QD, and polyvinyl amide.

11. The solid-phase adhesive of claim 1, wherein the solid-phase adhesive is an essentially homogeneous mixture.

12. The solid-phase adhesive of claim 1, wherein the solid-phase adhesive does not lose adhesion when elastically stretched.

13. The solid-phase adhesive of claim 1, wherein when the solid-phase adhesive is applied to and removed from human skin without causing medical adhesive-related skin injury.

14. The solid-phase adhesive of claim 1, wherein the solid-phase adhesive is provided in a film having a thickness of about 1 millimeter.

15. An adhesive object comprising the solid-phase adhesive of claim 1, wherein the object comprises bidirectional pathogen barrier surgical mask that filters both inhaled and exhaled air which may or may not incorporate an optional oxygen fitting and optional oximeter, a bidirectional pathogen barrier n-95 mask which may or may not incorporate an optional oxygen fitting and optional oximeter, panty-line-free panties, panty-line-free panties with built-in panty liner, panty-line-free panties with built-in sanitary napkin, medical adhesive tape, fashion adhesive tape, fashion and toupee adhesive double sided, adhesive nipple covers, adhesive strapless-backless brassiere, adjustable adhesive strapless-backless brassiere, medical device and/or electronic device adhesive, transdermal drug delivery system, analgesic patch, acne patch, bug bite patch, athletic tape, removable perfume patch, adhesive bandage, adhesive sharps disposal pad, ostomy skin barrier and hydrocolloid dressing, adhesive goggles, strapless shin guard, rug adhesive, external breast prosthesis adhesive, strapless elbow pad, cranial guard, breathing strip, adhesive sandal, American football shoulder pad with adhesive shock absorber on inner surface, moisturizing face mask, one magnet multipurpose mounting device, two magnet multipurpose mounting device, three magnet multipurpose mounting device, two magnet multipurpose mounting device holding face shield, two magnet multipurpose mounting device, shaped adhesive brassiere, lift brassiere, adhesive nose guard, decubitus ulcer mitigation pad, sports helmet with shock padding, gem dots, cosmetic foil, RFID sticky, stick-on camera, eye bag sleep moisturizer, loop multipurpose mounting device, two loop multipurpose mounting device, three loop multipurpose mounting device, snap multipurpose mounting device, two snap multipurpose mounting device, three snap multipurpose mounting, face shield and two magnet multipurpose mounting device holding face shield, hook and loop mounting tape, heel guard, decubitus ulcer mitigation pad, amputee stump sleeve, corn remover strip, callus cushion, adhesive gel toe separator, ball blister cushion, heel blister cushion, toe blister cushion, bunion cushion, bunion cushion, exfoliating foot peel, breast pump interface, flexible magnetic tape, and flexible magnetic sheet

16. The adhesive object of claim 15, wherein the low molecular weight resin comprises at least one of REGALREZ 1018 and 1033

17. The adhesive object of claim 15, wherein the low molecular weight resin comprises between about 70 weight percent and 95 weight percent of the solid-phase adhesive and wherein the hydrophobic liquid comprises between about 1 weight percent and about 15 weight percent of the solid-phase adhesive.

18. The adhesive object of claim 15, wherein the solid-phase adhesive has a Young's modulus of less than about 2 psi.

19. The adhesive object of claim 15, wherein the hydrophobic liquid comprises butyl stearate, butyloctanol, C12 alcane, C12-17 alcane, C14-22 alcane, caprylic/capric triglyceride, coco-caprylate, cocoyl adipic acid/trimethylolpropane copolymer, dicaprylyl ether, diethylhexyl sebacate, diisobutyl adipate, 1,2-cyclohexane dicarboxylic acid diisononyl ester, diisostearyl fumarate, diisostearyl malate, dimerdiol-carbonate, isododecane, hexyldecanol, hydrogenated poly(C6-14 olefin), hydrogenated polydecine, isononyl isononanoate, isopropyl shea butterate (and) dodecane (and) hexadecane, isostearyl isostearate, isostearyl lactate, lauryl lactate, lauryl lactyl lactate, neopentyl glycol diethylhexanoate, octyldodecanol, octyldodecyl lactate, octyldodecyl stearateo octyldodecyl stearoyl stearate, oleyl alcohol, oleyl erucate, oleyl lactate, PEG/PPG-8/3 diisostearate, polybutene, PPG-26/dimer dilinoleate copolymer (and) isononyl isononanoate (and) ethylhexyl isononanoate, propylene glycol dicaprylate/dicaprate, propylheptyl caprylate, triisostearyl citrate, undecane (and) tridecane) and combinations thereof.

20. The adhesive object of claim 15, and further comprising a hydrocolloid at a concentration of up to about 80 weight percent and wherein the hydrocolloid comprises sodium carboxymethyl cellulose, hydroxyethylcellulose, microcrystalline cellulose, xanthan gum, fructan gum, carrageenan, acacia senegal gum, tara gum, caesalpinia spinosa gum, guar gum, rhizobium gum, sclerotium gum, dehydroxanthan gum, natto gum, carboxymethylcellulose, biosaccharide gum-4, biosaccharide gum-2, hydrolyzed soy protein, biosaccharide gum-1, ceratonia siliqua (carob) gum, chondrus crispus, bentonite, agar, inulin, maltodextrin, polyglutamic acid, neutralized polyacrylic acid, neutralized methacrylic acid, polyquaternium-7 (neutralized 2-propen-1-aminium, N, N-dimethyl-N-2-propenyl-, chloride, polymer with 2-propenamide), neutralized dimethylaminoethyl methacrylate, neutralized 3-trimethylammonium propyl methacrylamide, neutralized 3-dimethylaminopropyl methacrylamide, neutralized acrylates copolymer, hydroxypropyl methylcellulose, hydroxypropyl cellulose, neutralized 2-propen-1-aminium, N,N-dimethyl-N-2-propenyl-, polymer with 2-propenoic acid, neutralized poly(diallyldimethylammonium, neutralized 2-propen-1-aminium, N,N-dimethyl-N-2-propenyl-, chloride, polymer with 2-propenamide and 2-propenoic acid, butendiol/vinyl alcohol copolymer, polyvinylpyrrolidone, polyvinyl caprolactam, carbomer, polyethylene glycol, polyethylene oxide, polyquaternium-10, guar hydroxypropyltrimonium chloride, cetyl hydroxyethylcellulose, sodium polystyrene sulfonate, schizophyllan, polyethyloxazoline, PEG-8 dimethicone (and) PEG-8 ricinoleate, calcium/sodium PVM/MA copolymer, 2-propenoic acid, 2-methyl-, polymer with butyl 2-propenoate and methyl 2-methyl-2-propenoate, galactoarabinan, carbomer 980 QD, and polyvinyl amide.
